(19) United States
(12) Patent Application Publication
(10) Pub. No.: US 2006/0294095 A1
(43) Pub. Date: Dec. 28, 2006

(54) Runtime thresholds for behavior detection

(75) Inventors: Mitchell F. Berk, Washington, DC (US); Seth P. Salmon, Washington, VA (US); Vineet K. Aggarwal, Ashburn, VA (US)

Correspondence Address: PEPPER HAMILTON LLP, ONE MELLON CENTER, 50TH FLOOR, 500 GRANT STREET, PITTSBURGH, PA, 15219, US

(73) Assignee: Mantas, Inc.

(21) Appl. No.: 11/148,472

(22) Filed: Jun. 9, 2005

(51) Int. Cl. G06F 7/00

(52) U.S. Cl. 707/6

(57) ABSTRACT

A computer based method and system for detecting behaviors from patterns of data where sets of thresholds and ranges used within detection scenarios can be created and applied while the system is in active operation. Data is received from at least one source, and an application environment is determined. A scenario including one or more parameterized patterns indicative of one or more behaviors is retrieved. One or more sets of parameters applicable to the one or more parameterized patterns are also retrieved. A parameter set is selected based on the application environment, and a dataset including a portion of the received data, one or more events, and one or more entities is formed. Detection processing is then performed by detecting one or more matches between the dataset and the parameterized patterns using the selected parameter set.

### TECHNICAL FIELD

The present disclosure generally relates to computer-implemented behavior detection methods and systems. More particularly, the present disclosure relates to the use of runtime thresholds in systems and methods for detecting behaviors.

### BACKGROUND

Businesses generate massive quantities of data representing a broad range of everyday activities. These activities may be as simple as a telephone call, a retail purchase or a bank deposit, or may be as complex as a series of financial securities transactions. Buried in these huge datasets are activities, events, and transactions that may reveal patterns and trends that are indicative (or predictive) of certain behaviors. These behaviors may show a certain buyer demographic profile or product preference (in retail purchase data, for example), or may indicate an emerging medical problem (in health insurance claims data). In the telecommunications industry, this data may show, for example, whether a caller is more likely to be a business or a residential customer. In the banking and securities industries, the data may reveal a violation of industry or government regulation or a breach of fiduciary responsibility.

Computer-based methods for detecting patterns in large datasets, sometimes called “data mining,” are well known in the art. For example, U.S. Pat. No. 6,480,844 to Cortes describes a method for inferring behavioral characteristics based on large volumes of telecommunications call data. These systems may perform one or more tests, where parameters in each of the tests are checked against a predetermined set of thresholds. Different combinations of parameters and thresholds can be established based on the requirements of the particular application. By allowing changes in the combinations of parameters and thresholds for specific behaviors, the user or installer can configure or reconfigure the system to detect events or combinations of events.

Prior art systems for the detection of specific behaviors are typically configured for a specific application environment (a particular business or institution, geographic area, jurisdiction, etc.). Application environments may differ in one or more ways. Some examples of differences among application environments are: currency, time zone, industry and government regulatory requirements, holidays, and liquidity of financial instruments. Employing these systems across a range of application environments with prior art systems requires the creation and maintenance of multiple scenarios, one for each application environment. This is both a logistical nightmare, and, potentially, a serious liability.

What is needed is the ability to set values for parameters (detection thresholds and ranges) more flexibly and dynamically and have new parameter values take effect in real time—while the detection system is in operation.

### SUMMARY

In an embodiment, systems and software used to detect behaviors from patterns of data may solve the problems described above by the creation and management of parameters used within detection scenarios (sets of thresholds and ranges) while the system is in active operation. This may allow users and administrators to create and maintain a single behavior detection scenario (for each behavior of interest) that may be distributed and appropriately parameterized to meet the needs of different application environments.

For example, a bank may have offices or branches in the United States, the United Kingdom, Germany, and Japan. Each of these countries has slightly different rules for reporting cash deposits. In this situation, a single behavior detection scenario that detects a failure to follow local regulatory practices may be created centrally with parameters that vary based on country or region. The scenario may be deployed to each of the regional offices or braches and may use the local parameter values for that region.

Accordingly, in an embodiment, a computer based method for detecting a behavior may include receiving data from at least one source; determining an application environment; retrieving a scenario including one or more parameterized patterns that are indicative of one or more behaviors; retrieving one or more sets of parameters applicable to the one or more parameterized patterns; selecting a set of parameters based on the application environment; forming a dataset including a portion of the received data, one or more events and one or more entities; and performing detection processing by detecting one or more matches between the dataset and the parameterized patterns with the parameters specific to the selected application environment.

Optionally, the method may generate one or more alerts and/or reports based on the discovery of one or more behaviors of interest. The method may also prioritize the behaviors of interest based on user-defined logic and values. It may also group the behaviors of interest, prioritize the groups, and generate one or more alerts based on the existence of groups or prioritized groups.

The method may be embodied in a computer program residing on a computer-readable medium.

In an embodiment, a method for configuring parameter sets for detection scenarios may include retrieving a base parameter set including one or more parameters for use in a detection scenario and a default value for each parameter, generating one or more derived parameter sets each including at least one parameter from the base parameter set, setting at least one parameter in each derived parameter set to a value different than the default value for the corresponding parameter in the base parameter set, and specifying, for each derived parameter set, an application environment to which the derived parameter set applies.

### BRIEF DESCRIPTION OF THE DRAWINGS

The accompanying drawings, which are incorporated in and form a part of the specification, illustrate embodiments of the present invention and, together with the description, serve to explain the principles of the invention. The embodiments illustrated in the drawings should not be read to constitute limiting requirements, but instead are intended to assist the reader in understanding the invention.

FIG. 1 depicts an exemplary user-relationship diagram of the advanced scenario based alert generation and processing system according to an embodiment.

FIG. 2 depicts an exemplary context diagram according to an embodiment.

FIG. 3 is an exemplary block diagram of the advanced scenario based alert generation and processing system according to an embodiment.

FIG. 4A depicts an exemplary flowchart of a scenario development process according to an embodiment.

FIG. 4B depicts an exemplary flowchart of a scenario tuning process according to an embodiment.

FIG. 4C depicts an exemplary flowchart of a detection process according to an embodiment.

FIG. 5 illustrates an exemplary range of complexity in behavior detection problems according to an embodiment.

FIG. 6 illustrates an n-dimensional space describing the problem of behavior detection according to an embodiment.

FIG. 7A depicts an exemplary data transformation process according to an embodiment.

FIG. 7B depicts representative tables involved in a data transformation process according to an embodiment.

FIG. 8 illustrates a representation of link analysis according to an embodiment.

FIG. 9 depicts a representation of sequence matching according to an embodiment.

FIG. 10 illustrates a representation of outlier detection according to an embodiment.

FIG. 11 depicts an exemplary networked infrastructure suitable for implementation of a system embodiment.

FIG. 12 depicts an exemplary block diagram for a computer within the system embodiment.

FIG. 13 illustrates an exemplary graphical user interface for a sequence scenario editor according to an embodiment.

FIG. 14A illustrates an exemplary graphical user interface for a threshold definer according to an embodiment.

FIG. 14B illustrates an exemplary graphical user interface for a threshold uses feature according to an embodiment.

FIG. 14C illustrates an exemplary graphical user interface for a threshold set feature according to an embodiment.

FIG. 15 illustrates an exemplary graphical user interface and display for network visualization of alerts according to an embodiment.

FIG. 16 illustrates an exemplary graphical user interface for alert display, alert filtering and alert viewing according to an embodiment.

FIG. 17 illustrates an exemplary graphical user interface for viewing alert details according to an embodiment.

FIG. 18 illustrates an exemplary graphical user interface for viewing alert details according to an embodiment.

FIG. 19 illustrates an exemplary graphical user interface for workload management according to an embodiment.

FIG. 20 illustrates an exemplary graphical user interface for alert disposition according to an embodiment.

### DETAILED DESCRIPTION

In describing an embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose. In addition, the drawings illustrate examples of preferred embodiments of the invention and should not be construed as limiting or requiring certain features.

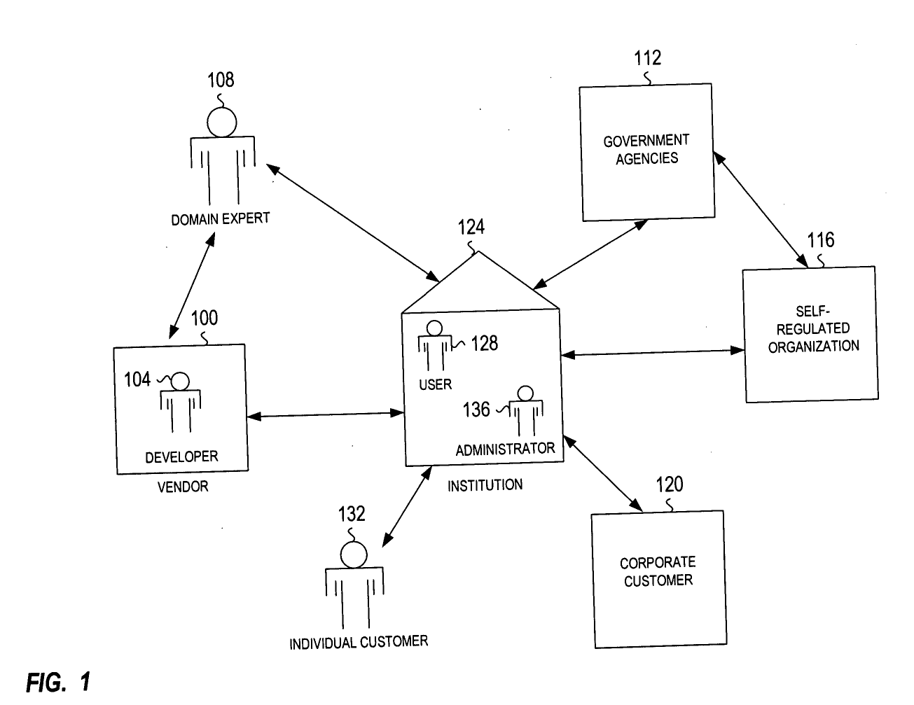

In an embodiment, an advanced scenario-based behavior detection system may allow for the creation and management of parameters (sets of thresholds and ranges) used within detection scenarios while the system is in active operation. FIG. 1 depicts an exemplary user-relationship diagram of the advanced scenario based alert generation and processing system according to an embodiment. Referring to FIG. 1, a vendor 100 with a developer 104 may work directly with a domain expert 108, an institution 124, an administrator 136 and/or a user 128 in developing, creating and implementing information based products and services. A domain expert 108 has, generally speaking, specialized knowledge about the application and may act as a subject matter expert. An administrator 136 and a user 128 may monitor both individual customers 132 as well as corporate customers 120. A self-regulated organization 116 may develop rules and regulations that its members (e.g. an institution 124) adhere to, either for preservation of the industry or to comply with government regulations.

As an example, an institution 124 may be a U.S. securities brokerage that services individuals as well as corporations. The Securities and Exchange Commission (SEC) requires such an institution 124 to perform self-monitoring, which it does according to the standards set by the National Association of Securities Dealers (NASD), an example of a self-regulated organization 116.

An institution 124 and/or a self regulated organization 116 may be subject to regulation by a variety of government agencies 112, such as, for example, the Internal Revenue Service (IRS), Federal Bureau of Investigation (FBI), U.S. Treasury, SEC and Bureau of Citizenship and Services (BCIS). An institution 124 may be subject to and/or a member of a self-regulating organization 116, such as professional or financial associations that provide operating guidelines for their members with the goal of being self-regulating (as opposed to government regulated).

Detecting behaviors may be important to an institution 124 for purposes of better understanding or protecting its customers or for reporting certain behaviors to government agencies. A self-regulated organization 116 may also require its member institutions to perform a specific level and/or type of behavior monitoring in order to ensure that all members are compliant with the organization's rules.

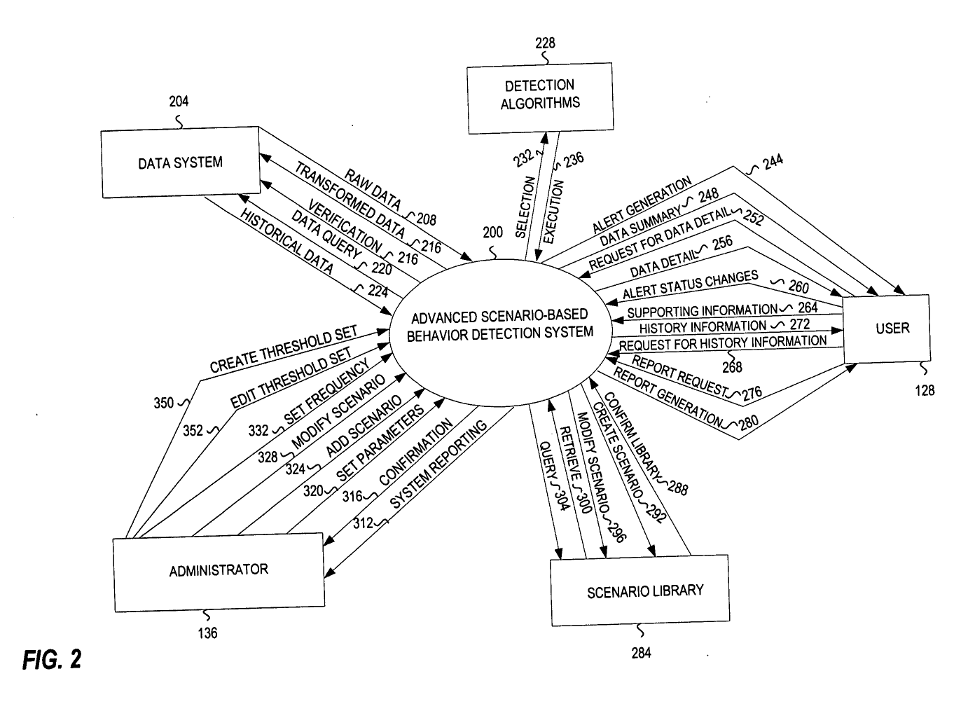

FIG. 2 depicts an exemplary context diagram according to an embodiment. A context-diagram shows the scope or environment of a system, the key entities that interact with the system, and the important information flows between the entities and the system. The main elements of this environment may include, but are not limited to, a data system 204, detection algorithms 228, a user 128, a scenario library 284 and an administrator 136.

In interfacing with the advanced scenario-based behavior detection system 200, the administrator 136 may set a frequency 332 which determines the frequency with which the advanced scenario-based behavior detection system 200 performs its advanced capabilities. Furthermore, the administrator 136 may modify a scenario 328 by accessing an existing scenario from the scenario library 284 in order to make and save desired changes. Additional scenarios may be added by the administrator 136 through an add scenario 324 capability, thereby allowing for continuous upgrading and enhancing of the advanced scenario-based behavior detection system 200. The administrator 136 may also set parameters 320 enabling greater flexibility and capability in detecting desired behaviors, transactions or relationships across entities and events. The advanced scenario-based behavior detection system 200 may be capable of sending confirmation 316 of the set frequency 332, modify scenario 328, add scenario 324 and set parameters 320. The advanced scenario-based behavior detection system 200 may also provide system reporting 312, which could include information such as error reporting, system performance or other desired and relevant information.

A threshold is a parameter value that is used within a scenario to implement the scenario logic. For example, a scenario might specify a minimum order value of $100,000 in order to catch large securities purchases that may have been made in violation of securities regulations. A threshold set is a collection of thresholds that are associated to a scenario. The administrator 136 may create a threshold set 350 and edit a threshold set 352 to enable a particular scenario to be distributed and appropriately parameterized to meet the needs of different application environments.

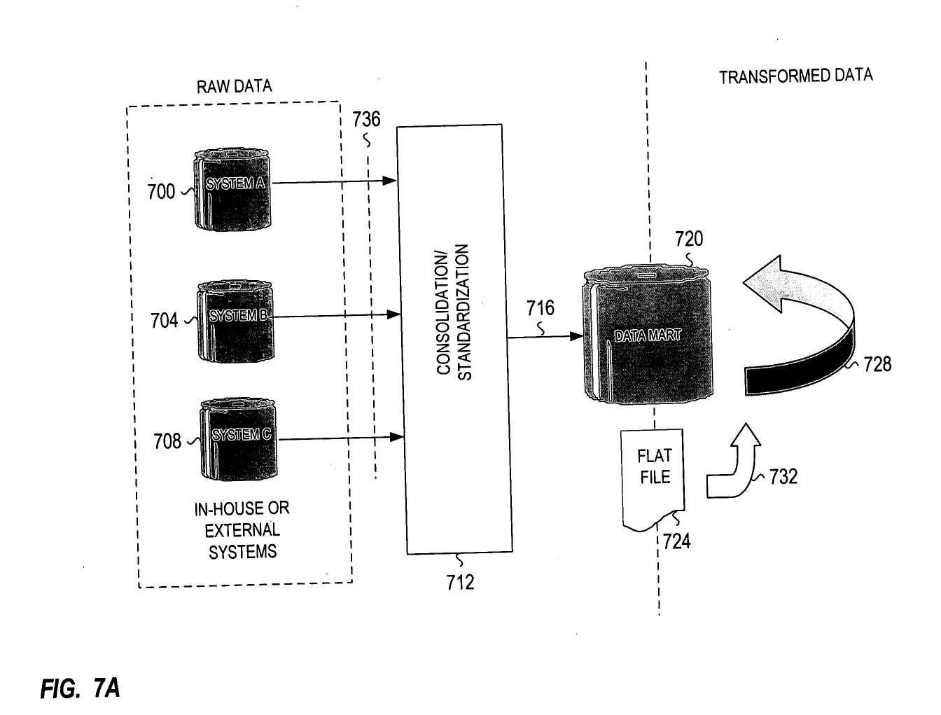

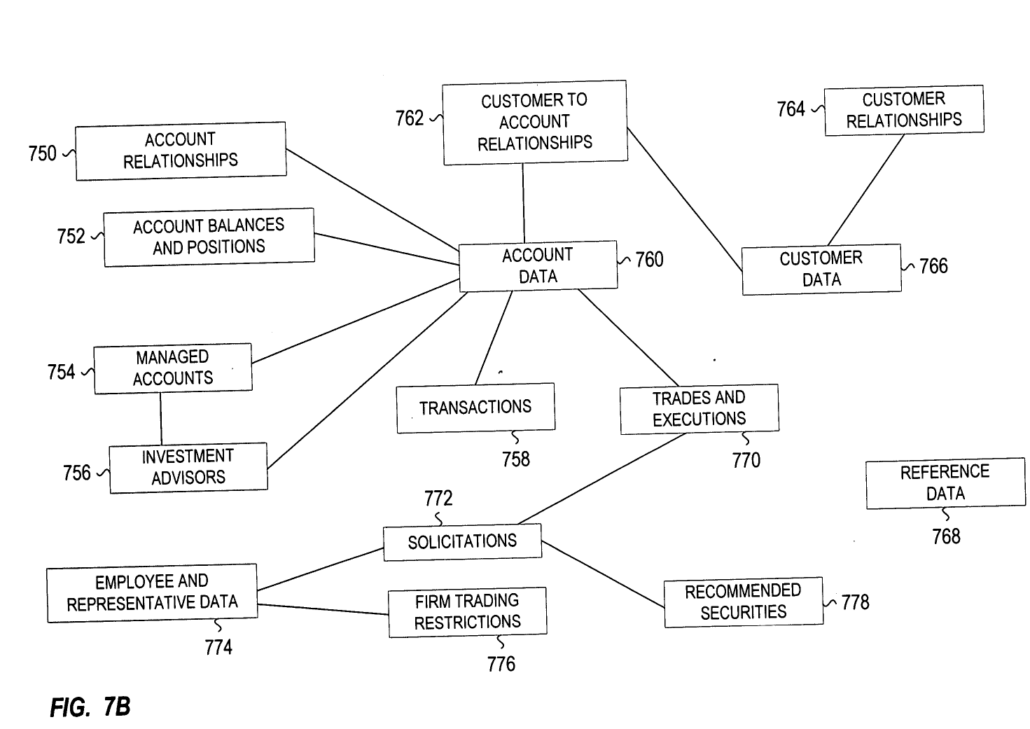

The advanced scenario-based behavior detection system 200 may receive raw data 208 from the data system 204. The advanced scenario-based behavior detection system 200 may then transform the data and send back transformed data 212 to the data system 204. The process of transforming data is illustrated in FIG. 7A and described below in the text accompanying FIG. 7A. The advanced scenario-based behavior detection system 200 may provide verification 216 of the data integrity through any of a variety of error detection processes that will be readily known to those skilled in the art. The advanced scenario-based behavior detection system 200 may then send a data query 220 to the data system 204 in which historical data 224 may be retrieved as input for the advanced scenario-based behavior detection system 200. Once the historical data 224 is available for the advanced scenario-based behavior detection system 200, detection algorithms 228 may be accessed for selection 232 and execution 236 of the desired and appropriate algorithm.

A variety of detection algorithms 228 may be applied. The types of algorithms may include, but are not limited to, link analysis, sequence matching, outlier detection, rule patterns, text mining, decision trees and neural networks.

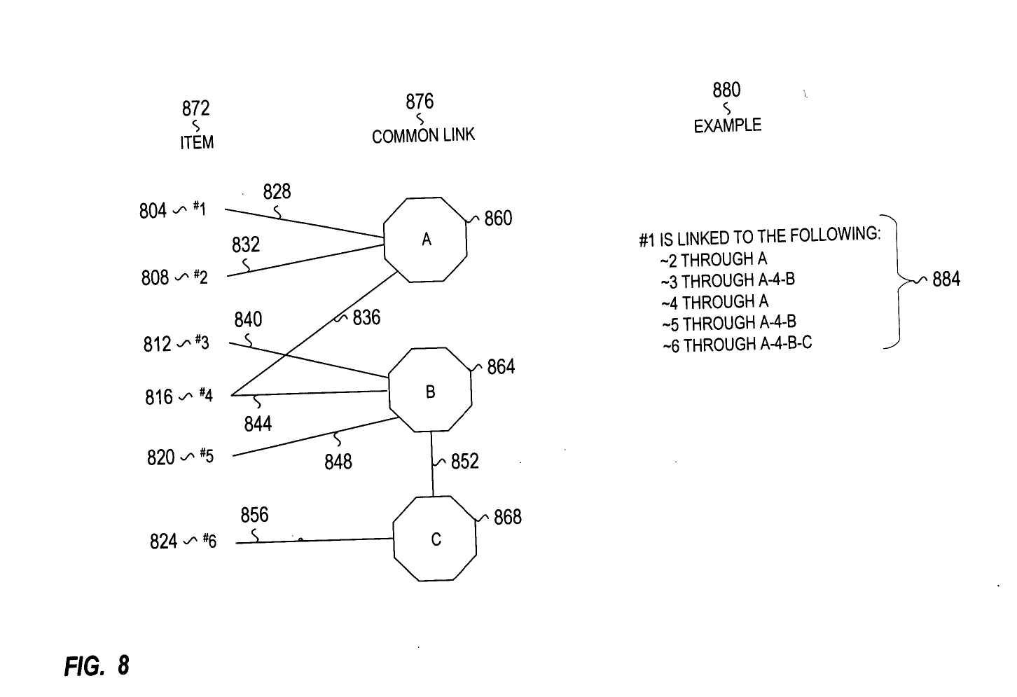

Link analysis is an advanced behavior detection algorithm that analyzes seemingly unrelated accounts, activities, events and behaviors to determine whether possible links and/or hidden relationships exist. FIG. 8, which will be described below in greater detail, is illustrative of link analysis.

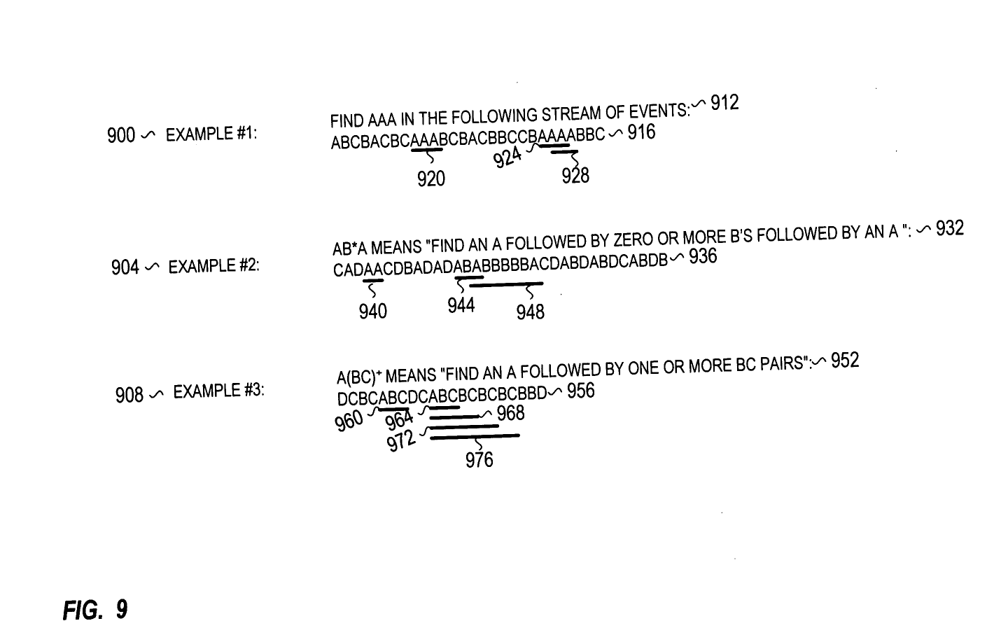

Sequence matching may be used to identify a range of events, behaviors or activities in a pattern of relevant sequences. While a single event, behavior or activity may not always be interesting, when compared to the position of such event, behavior or activity within a larger context, certain interesting trends or sequences may be detected. FIG. 9, which will be described below in greater detail, is illustrative of sequence matching.

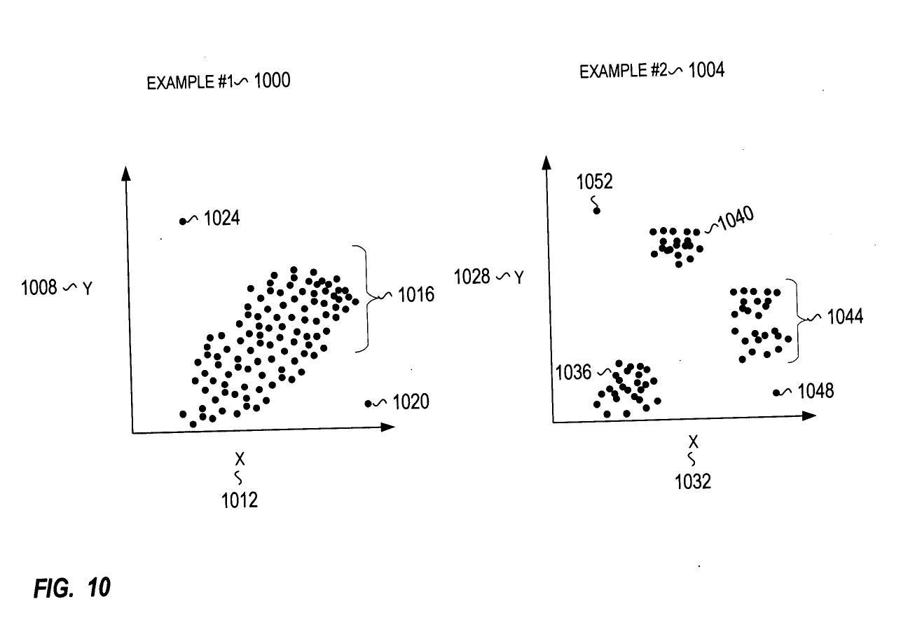

Outlier detection examines data values to determine specific events, behaviors or activities that fall outside of a specified statistical range. A simplistic approach may include using regression modeling in identifying outliers, which are beyond a specified standard deviation. A more sophisticated approach may include identifying outliers in the context of data clusters where multiple data clusters may exist rendering a regression model ineffective. FIG. 10, which will be described below in greater detail, is illustrative of outlier detection.

Rule pattern detection implements conditional statements when analyzing data, generally in the form of “if-then” statements. Text mining algorithms examine data for specific text phrases, sequences or information that may be provided as inputs to a behavior detector. Decision trees and neural networks are related approaches that examine a sequence of events, behaviors or activities using logical rules or specific networks well known by those skilled in the art.

Additional algorithms may also be accessed by the advanced scenario-based behavior detection system 200 in identifying interesting behaviors, events, activities or transactions. Once a detection algorithm has been selected, the advanced scenario-based behavior detection system 200 may access the scenario library 284 to apply the relevant and appropriate scenario, in conjunction with the detection algorithm, to create matches of desired behaviors, activities or events in a complex environment. The scenario library 284 may contain a plurality of advanced scenarios and basic scenarios for identifying activities, behaviors or events of interest.

The advanced scenario-based behavior detection-system 200 may send a query 304 to the scenario library 284 accessing a specific scenario. The scenario library 284 may then retrieve 300 the selected scenario and send it back to the advanced scenario-based behavior detection system 200. Based on the specific scenario retrieved, the advanced scenario-based behavior detection system 200 may then send a data query 220 to the data system 204 in which historical data 224 may be retrieved as input for the advanced scenario-based behavior detection system 200. In addition, the advanced scenario-based behavior detection system 200 may send requests to modify a scenario 296 or create a scenario 292 to the scenario library 284. The scenario library 284 may confirm the library 288 to the advanced scenario-based behavior detection system 200. The flexibility and capability to add or modify elements of the scenario library 284 and detection algorithms 228 allow the advanced scenario-based behavior detection system 200 to be continuously upgraded and dynamically maintained. Once the desired and appropriate detection algorithm has been selected and the desired and appropriate scenario applied, the advanced scenario-based behavior detection system 200 may process the data by generating a report 280 or alert 244 that may be sent to the user 128. Furthermore, the advanced scenario-based behavior detection system 200 may send a data summary 248 related to the alert generation 244 to the user 128 in order to provide immediate access to relevant information related to the detected activity, behavior or circumstances. The user 128 may send a request for data detail 252 to the advanced scenario-based behavior detection system 200 which may provide, in response, additional underlying data related to the data summary 248 and alert generation 244. The advanced scenario-based behavior detection system 200 may send the data detail 256 to the user 128 based on the request for data detail 252.

This additional information, when combined with the original information received, allows the user 128 to elect an alert status change 260, which is transmitted back to the advanced scenario-based behavior detection system 200. Furthermore, the user 128 may provide supporting information 264 back to the advanced scenario-based behavior detection system 200. This supporting information 264 may include, but is not limited to, comments, findings, opinions or other data that support the user's request to implement an alert status change 260. In addition, the user 128 may request additional historical information 268 from the advanced scenario-based behavior detection system 200. This may provide the user 128 with additional information in which to place the context of the alert generation 244. The advanced scenario-based behavior detection system 200 may then send the requested history information 272 to the user 128. Furthermore, the user 128 may send a report request 276 to the advanced scenario-based behavior detection system 200, which may then provide the desired information through report generation 280 back to the user 128.

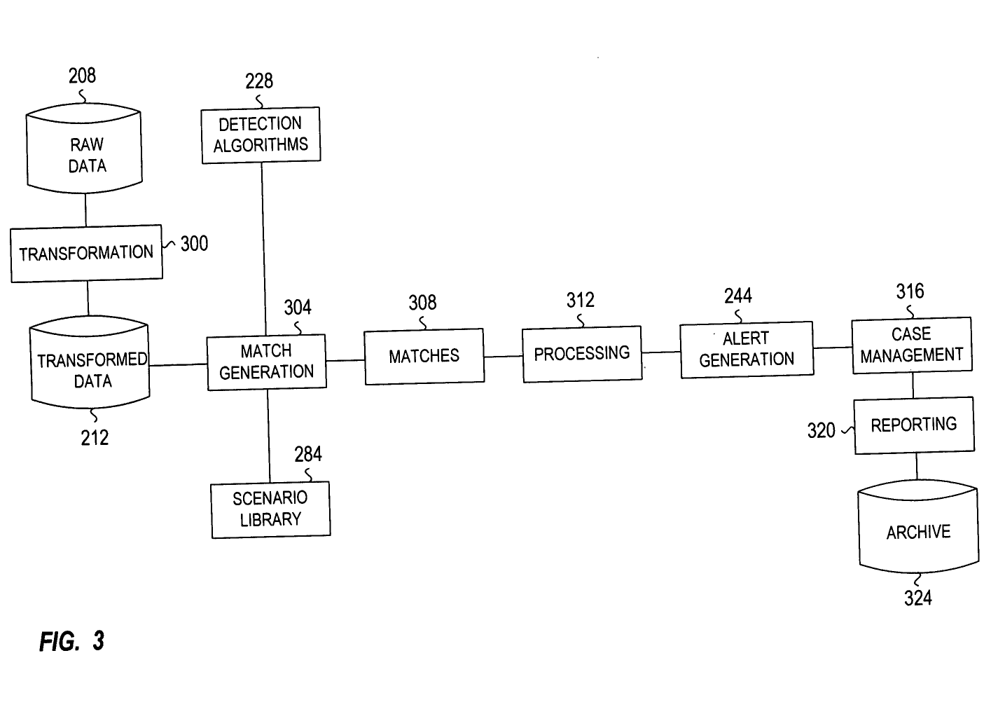

FIG. 3 is an exemplary block diagram of the advanced scenario based alert generation and processing system according to an embodiment. Raw data 208 is converted through a transformation step 300, elements of which are described below in reference to FIG. 7A. The output of the transformation may be saved as transformed data 212. Match generation 304 may then access the transformed data 212, detection algorithms 228 and scenario library 284. The scenarios in the scenario library 284 may be represented as parameters and logic that specifically relate to the behavior of interest. In one embodiment, the parameters and logic may be coded in Extensible Markup Language (XML). In one embodiment, match generation 304 may be written in C++ and may retrieve the parameters and logic from the scenario library 284, allowing the detection algorithms to operate on the transformed data. The match generation 304 may then generate matches 308. Each match 308 may undergo processing 312 as it is grouped and prioritized. Processing 312 may include the ability to prioritize or weigh different elements of the activity, event or behavior of interest. Alert generation 244 may receive processed (grouped and prioritized) matches from processing 312 and, in one embodiment, may store those matches as an XML file. In many cases, particular identified events, behaviors or activities of interest may provide relatively little information. However, when viewed within a broader context as part of other transactions, the cumulative effect of the events, behaviors or activities of interest may be of much greater import than the individual elements. As such, a grouping of activities, events and behaviors of interest may provide an advanced capability not presently available. Furthermore, the prioritization may allow for greater segmentation of the data so that matches with higher impact or importance receive greater attention or are considered more quickly.

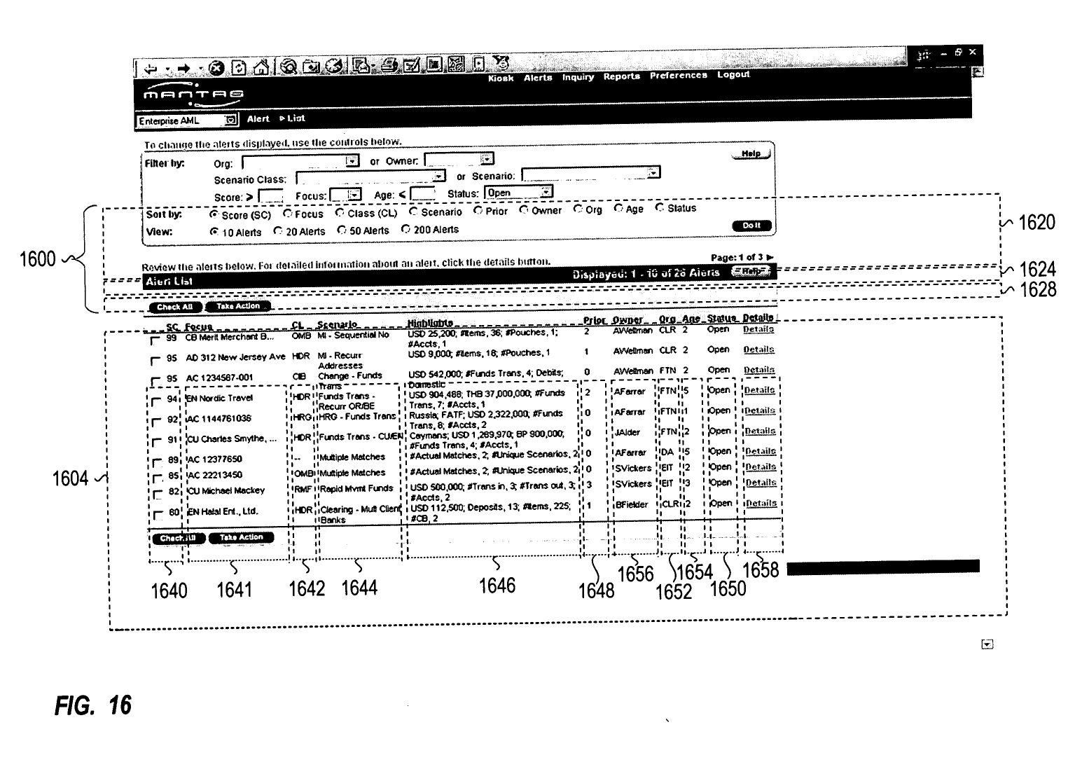

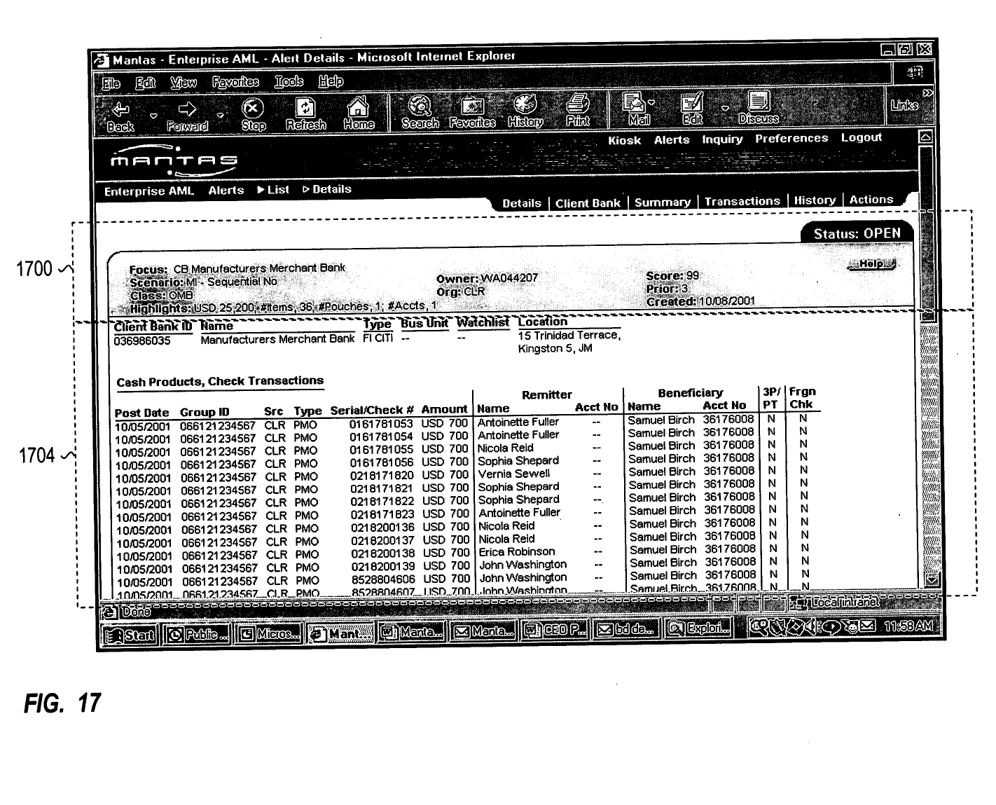

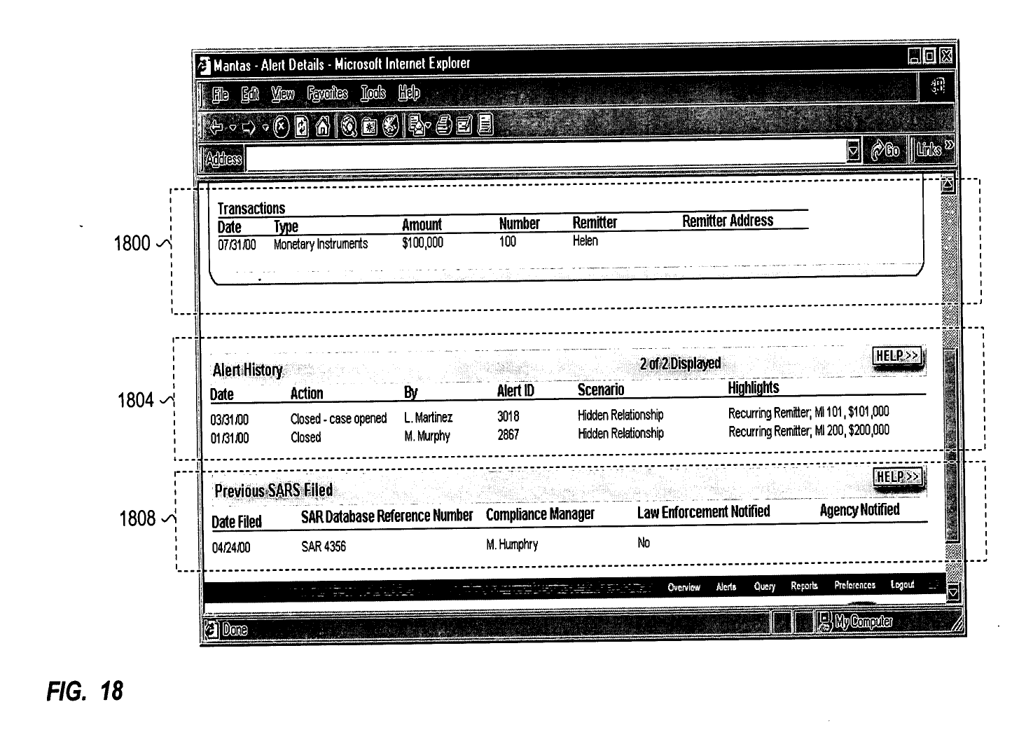

Referring again to FIG. 3, alert generation 244 may transfer relevant information regarding behaviors, activities and events of interest into case management 316, which reviews analyzes and investigates the information further. Case management 316 may include a set of tools and user interfaces that allow alerts to be reviewed, analyzed and investigated by a human operator. Case management 316 may also allow a user 128 to enter data related to an alert, close an alert, refer an alert to another user or perform other tasks on an individual alert. In one embodiment, case management 316 may provide a user interface, such as that shown in FIG. 16, including a high-level description of the alert. Case management 316 may also support the filtering of the alerts using, for example, the fields shown in FIG. 16 as filtering elements 1600. Case management 316 may also provide user interfaces such as those shown in FIGS. 17 and 18. When alerts are stored in an XML format, a number of commercially available case management tools may be used to process such alerts. Examples of commercially available case management tools include, but are not limited to, TightLink CIS 3™ and Syfact™. In one embodiment, a web-based application written in Java® may be used for case management 316.

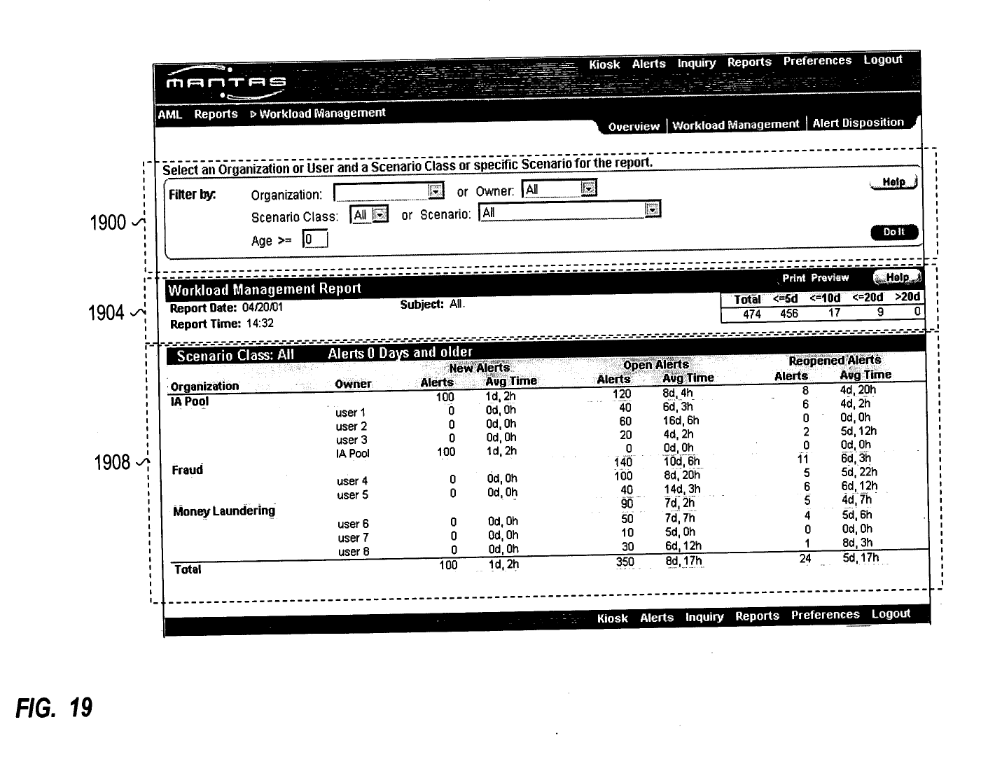

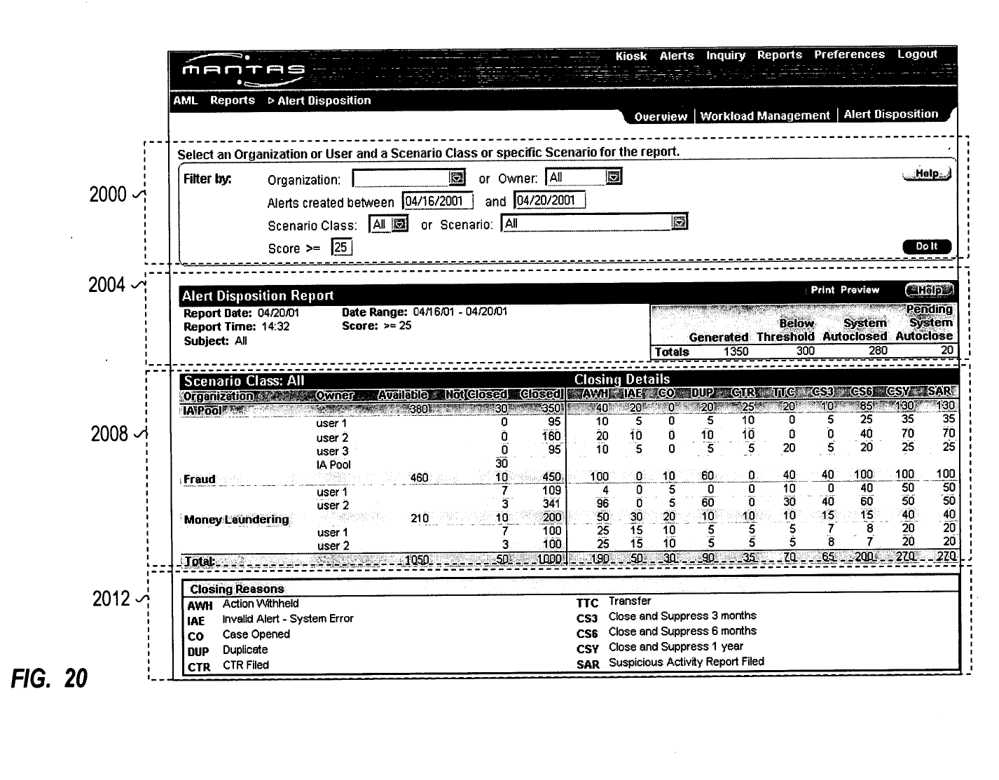

After the alert is processed, information may be transferred to reporting 320 and saved in an archive 324. Exemplary reporting 320 outputs are illustrated in FIGS. 19 and 20, where workload management and alert dispositioning are shown respectively. A number of commercially available reporting tools may be used to report on workload management, dispositioning and other areas of interest. Examples of commercially available case reporting tools include, but are not limited to, Crystal Reports™ sold by Crystal Decisions, the product manufactured by Statewide Data Warehouse and sold under the product name Brio™ or the e.Reporting Suite™ offered by Actuate. In one embodiment, a web-based application written in Java® may be used for reporting 320. The ability to save the alert data and related workflow activities in archive 324 may permit the processes used to create the alert data and establish the workflow to be recalled and modified as necessary.

In an embodiment, a computer process may include sub-processes for link analysis, sequence matching, outlier detection and rules-based detection for match generation 304. Such sub-processes may instruct the system to access transformed data 212, select detection algorithms 228 and apply the appropriate scenario library 284 in the match generation process 304. Once match generation 304 completes, the processing 312 of matches 308 identified in match generation 304 may occur. Processing 312 may include prioritizing matches 308, grouping matches 308 and prioritizing alerts. The match prioritization sub-process may receive match information and prioritization strategy logic and evaluate matches 308 to assign a ranking or prioritization to each match 308. The match grouping sub-process may access a set of prioritized matches and grouping strategy logic, evaluate prioritized matches and create group associations based on the grouping strategy logic. The grouped prioritized matches may form an output of the advanced scenario-based behavior detection system 200. The alert prioritization sub-process may receive a set of grouped matches and alert prioritization strategy logic, evaluate the grouped matches based on the alert prioritization strategy logic, and assign an alert prioritization based on the evaluation. The group matches may be output based on alert prioritization by the advanced scenario-based behavior detection system 200.

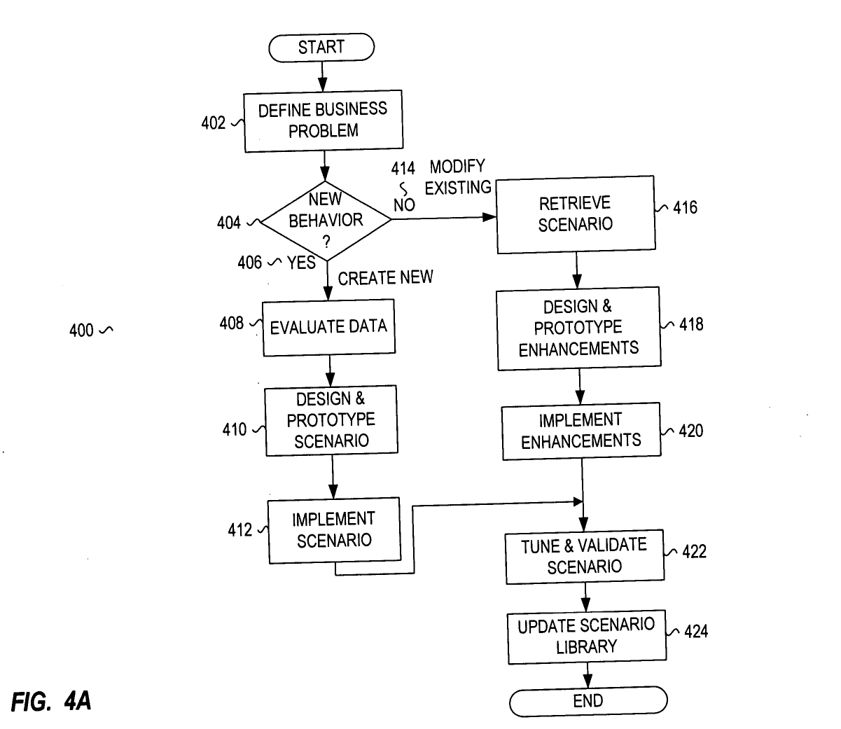

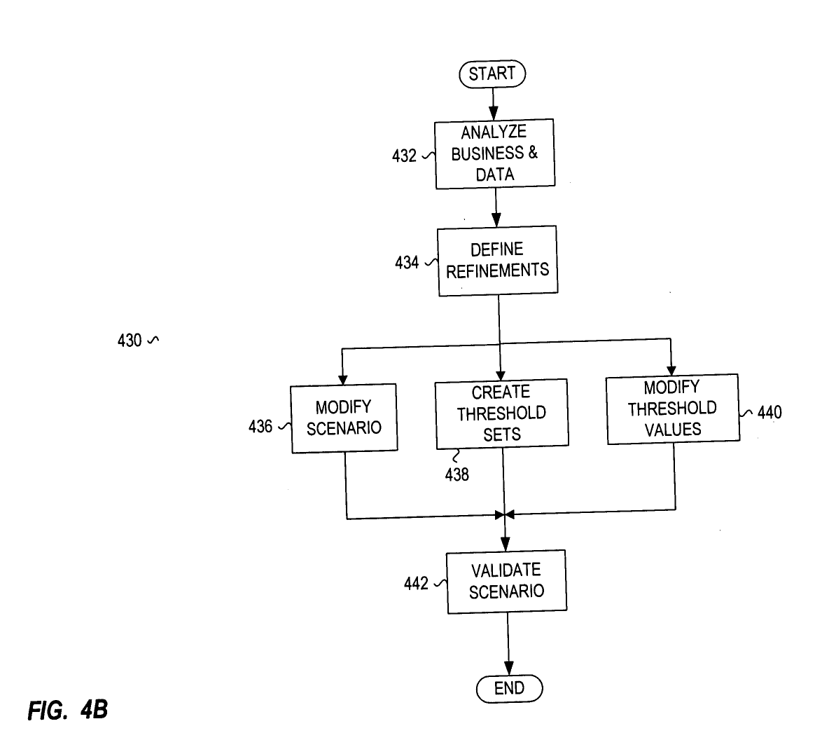

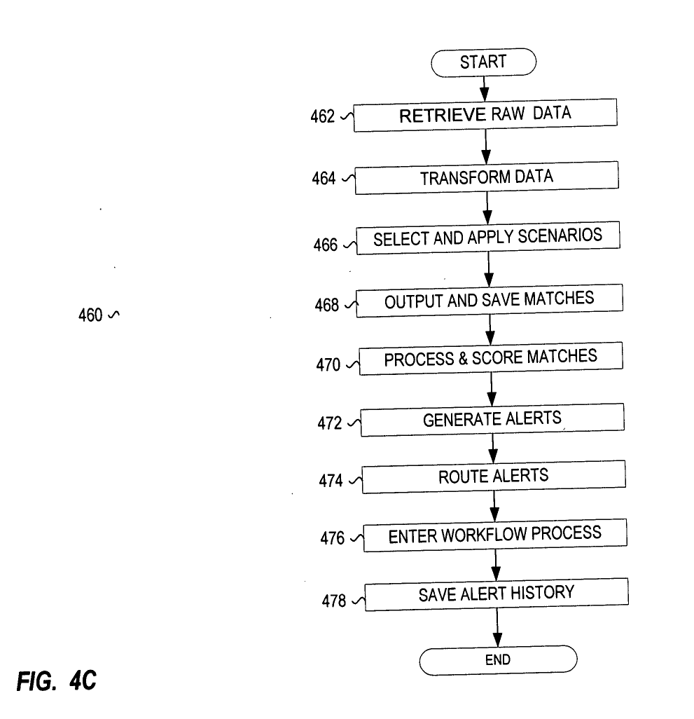

FIG. 4A depicts an exemplary flowchart of a scenario development process according to an embodiment. Referring to FIG. 4A, the scenario development process 400 may initially define a business problem 402. The business problem may relate to a need to detect evidence of certain patterns of behavior in transaction data, such as the detection of fraudulent financial transactions or money laundering activity. The business problem definition 402 may result in a behavior pattern or set of behaviors to be detected. A test may be performed 404 to determine if this behavior is new (i.e., no other behaviors in the scenario library 284 are identical or similar to the newly defined problem). If this is a new behavior 406, a new scenario may be created by evaluating data 408 that is pertinent to the business problem and associated behavior and designing and prototyping 410 a scenario. Once designed and prototyped, the scenario may be implemented 412. If test 404 determines that the behavior is identical or similar to an existing scenario, the existing scenario may be modified 414 to include the new behavior. The scenario modification process may retrieve the appropriate scenario 416 from the scenario library 284, design and prototype the enhancements 418 to the existing scenario based on the new business requirements, and then implement these enhancements 420. The newly implemented or modified scenario may be tuned and validated 422 by using the scenario in an advanced scenario-based behavior detection system 200 with actual or test data. The scenario library 284 may then be updated 424 with the newly created or modified scenario.

FIG. 4B depicts an exemplary flowchart of a scenario tuning process according to an embodiment. Referring to FIG. 4B, the scenario tuning process 430 may initially analyze a business and its data 432 in order to understand which aspects of the previously defined business problems may be refined and parameterized. For example, a bank may have branches in different countries (application environments) having differing regulatory requirements. If reporting requirements are similarly structured in several different application environments, differing only in specific threshold values, currencies, or other parameters, scenarios may be parameterized and threshold sets can be defined for each application environment. Once the analysis 432 has been completed, refinements to the scenarios may be defined 434. Depending on the required scenario refinements, one or more actions may be taken. In one embodiment, the scenario may be modified 436 based on the newly analyzed information. If the analysis reveals that parameterization of a scenario is appropriate, as in the banking regulatory situation described above, threshold sets may be created 438 for each regulatory environment. Threshold values may be modified 440 as necessary. Once all of the necessary refinements are made to a scenario, the revised scenario may be validated 442 before being used in a production environment (behavior detection process).

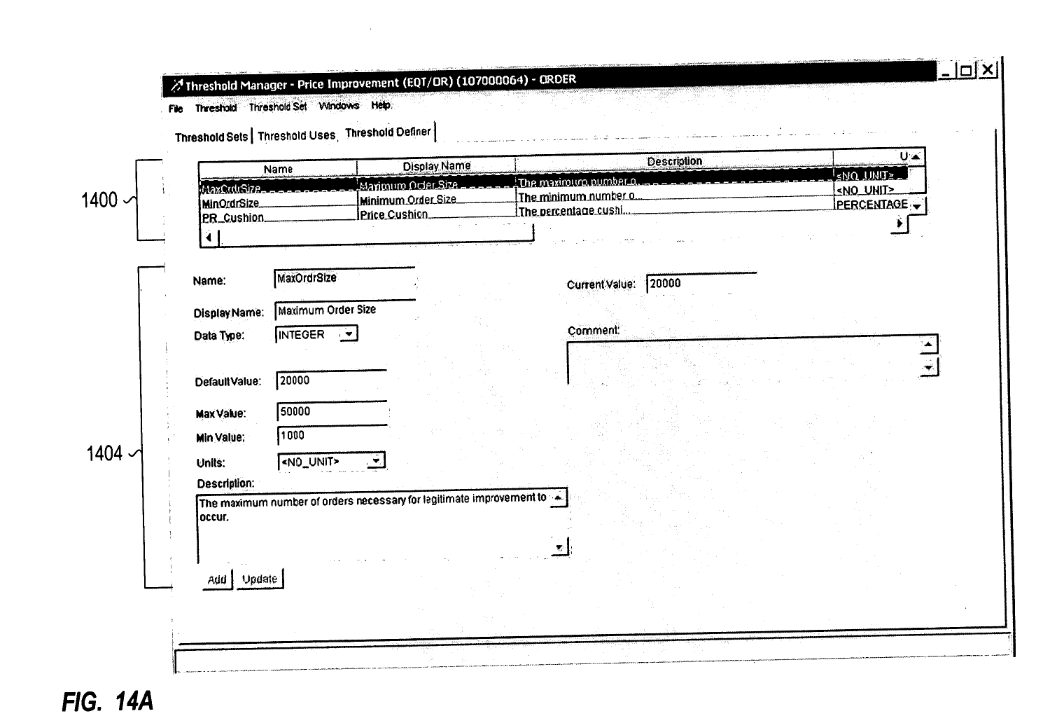

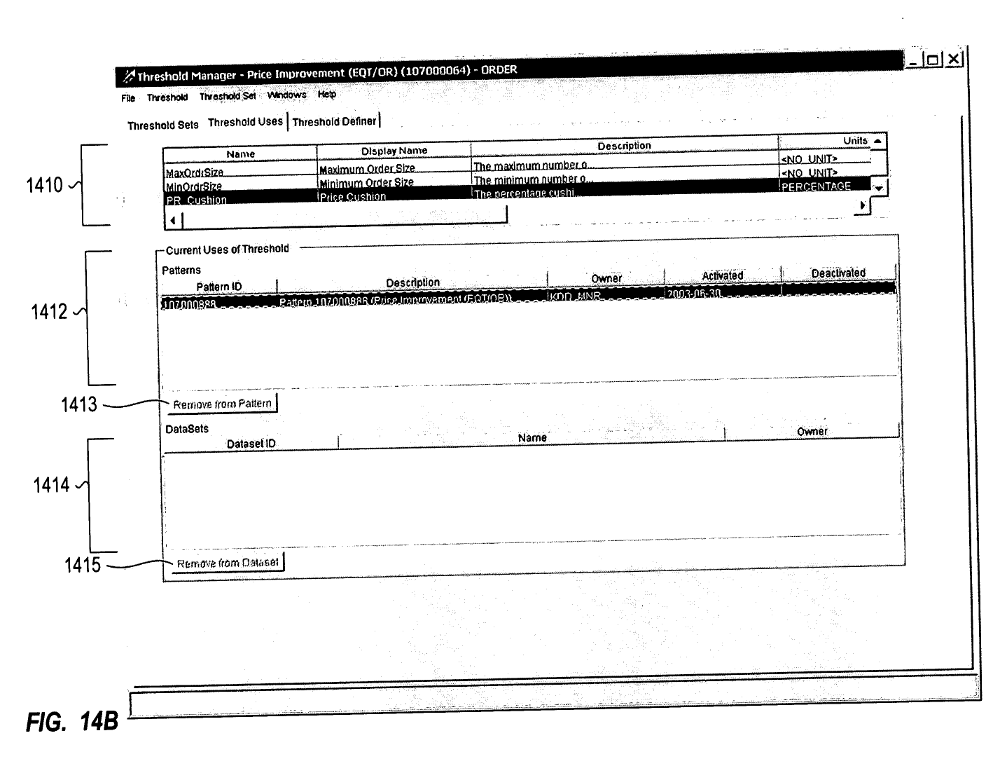

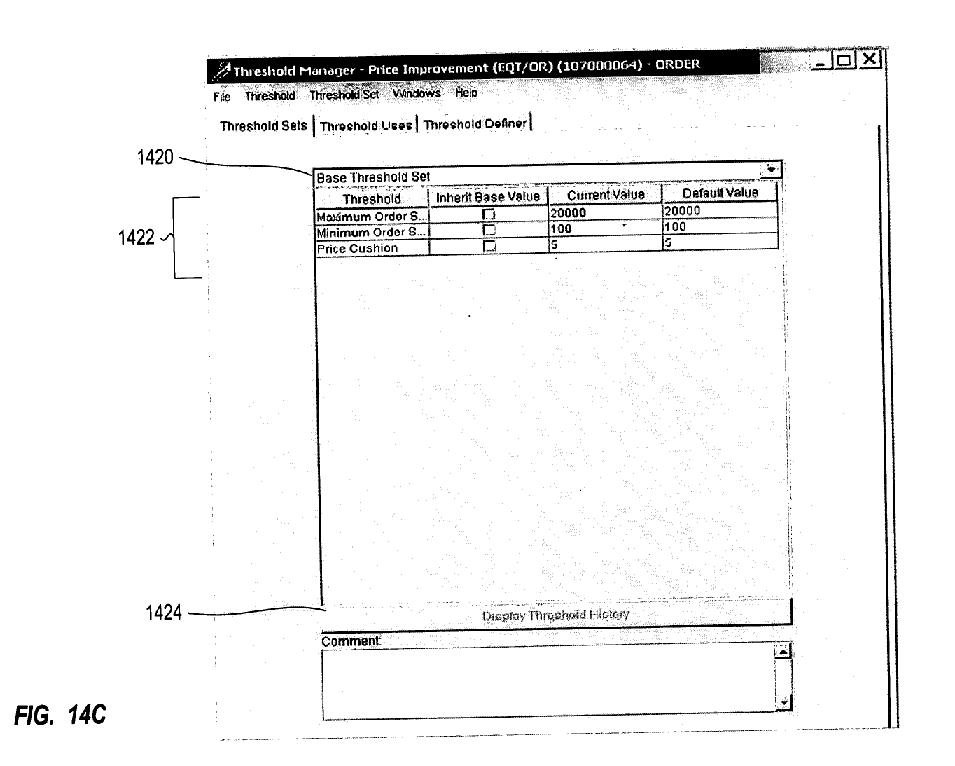

FIG. 4C depicts an exemplary flowchart of a detection process according to an embodiment. Referring to FIG. 4C, the behavior detection process 460 may initially retrieve raw data 462. The raw data may be transformed 464, if necessary, to a form that is more amenable to processing with the advanced scenario-based behavior detection system 200. One example of a data transformation process is illustrated in FIG. 7A and described in detail below. The system may then select and apply scenarios and detection algorithms 466, which may additionally include the selection of an application environment and a threshold set appropriate for the selected application environment. The system may then output and save matches 468, process and score matches 470, generate alerts 472, route alerts 474, enter the workflow process 476, and/or save the alert history 478. The process and score matches step 470 may be included in the processing 312 sequence. The route alerts 474 and enter workflow process 476 steps may be included in the case management 316 sequence. The save alert history step 478 may be included in the archive 324 sequence. FIGS. 14A-C (described in detail below) depict an exemplary definition and selection of sets of parameter values (threshold sets) for a particular scenario and particular application environments.

A basic scenario may define events and/or entities that are known to be indicative of a behavior of interest. Basic scenarios may typically include a single event, a single entity, or a small number of events and/or entities that operate on a set of data to determine if the scenario of interest is present. An exemplary basic scenario is an exception report. An exception report may flag individual transactions and produce a list of transactions abstracted from the context in which they occurred. Evaluation of the exceptions based solely on the information provided in the exception report may be difficult or, in some cases, impossible.

Basic behavior detection is a method of detection that observes a single event or a simple aggregate of events. For example, basic behavior detection of money laundering may be performed by defining a basic money laundering scenario of “all cash transactions over $10,000” and generating an exception report indicating all of those transactions. One difficulty with implementing this approach is that the exception report would inherently have a high false alarm rate since many of the identified transactions would be legitimate and not indicative of fraudulent behavior.

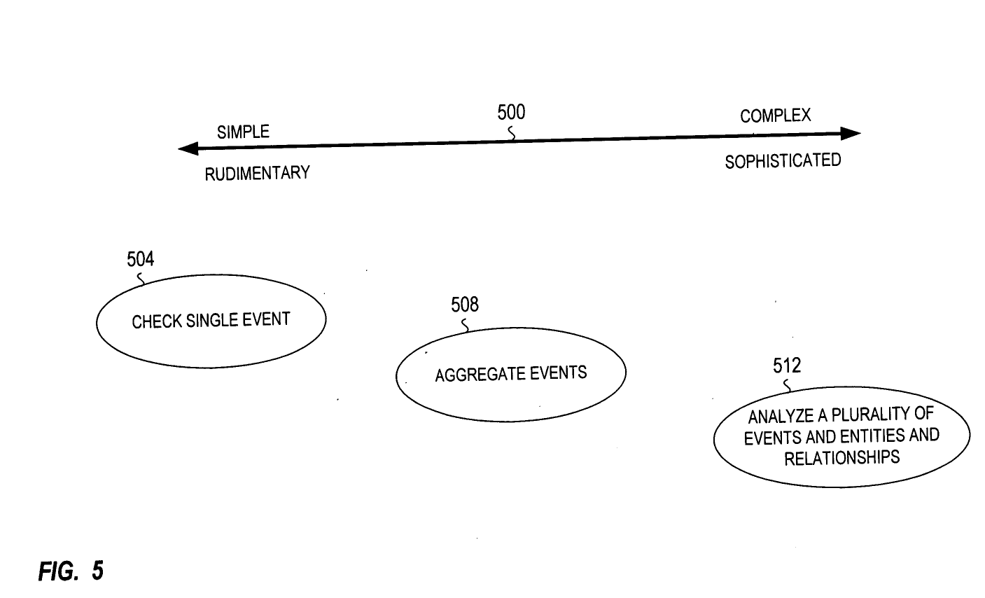

FIG. 5 illustrates an exemplary range of complexity in behavior detection problems according to an embodiment. Scale 500 represents the spectrum of simple detection using rudimentary approaches to complex detection using advanced scenarios. Checking a single event 504 may represent solutions based on the evaluation of a single data event or transactions in assessing behavior. Examples include, but are not limited to, currency transactions above a certain size, phone calls made by a consumer above or below certain thresholds or web site visits to a particular site. Filtering or other approaches may identify behaviors, activities or events of interest based on a single criterion, but the reliability with which the behavior is detected may be low. Aggregate events 508 may represent approaches incorporating the use of multiple event tests for determining behavior, activities or events of interest, such as identifying customers whose total purchases surpass a threshold during a period of time. The aggregation of all customer purchases may identify those customers whose behaviors are of interest.

Although these basic scenarios may be useful in identifying the behavior of interest, those committing the behavior may often be aware of the basic scenarios and may modify their behaviors, actions and activities to avoid detection.

An advanced scenario may create a rich package of information that allows the behavior of interest to be observed or investigated in context. An advanced scenario may contain the elements of focus, highlights, specific events and entities and/or parameterized logic.

A focus is a centralized event or entity upon which the behavior may be further investigated. For example, a focus may include a customer suspected of laundering money. Another example may include a central account linked to a number of other accounts. Although all of the accounts would be subject to investigation and tied to the alert, the focus may be the central account. An exemplary presentation of the focus is depicted in the focus column 1641 of the alert list 1604 in FIG. 16.

Highlights are summarizations of the events and entities involved in an alert representing a behavior. Exemplary highlights may include the total dollar amount passed through an account or the total number of transactions by an account. A highlight may summarize and identify why a set of events and/or entities is of interest, but may not list specific events and/or entities. An exemplary representation of highlights is depicted in the highlights column 1646 of the alert list 1604 in FIG. 16.

An advanced scenario may link an alert to specific events and/or entities that have resulted in the generation of that alert. For example, a set of accounts that are allegedly part of a money laundering ring (entities) and deposits into and withdrawals from those accounts (events) may be linked to an alert. An illustration of the specific events and entities that may result in the generation of an alert are shown in alert details 1704 of FIG. 17.

An advanced scenario may contain logic that determines whether or not a match and/or an alert are generated. This logic may include parameters, accessible to a user 128 and/or an administrator 136 through a user interface that may be varied to define a threshold or a rule to generate a match and/or an alert. Exemplary parameterized logic may include “a money laundering ring must include x different accounts and y different transactions.” In this example, x and y may initially be set to 3 and 40, respectively. Those values may later be altered, by a machine or a user, based on the number of false positives generated. An illustration of parameterized logic is shown in the threshold parameters section 1404 of FIG. 14.

Advanced behavior detection may require the analysis of a plurality of events and entities and the relationships between events and/or entities. For example, a drug dealer wants to get large amounts of cash into the banking system, but knows that if he/she deposits cash, the bank will file a government form on him/her. To avoid detection, the dealer decides to buy money orders with the cash because money orders are regulated less rigorously. The dealer also knows that if he/she buys $3,000 or more in money orders at one time, the dealer has to supply a personal identification. To avoid this, the dealer travels around to several convenience stores and buys five $500 money orders at each store. The dealer then deposits all the money orders at the bank, but to avoid suspicion, the dealer makes the deposits at several branches over several days into several accounts. The dealer later consolidates the money into one account and wires it to an account in the Cayman Islands. The dealer used several bank accounts that on the surface looked independent (e.g., by using different names, addresses, etc.), but were in fact controlled by one person in order to launder money. The serial numbers on his money orders also were in sequential groups of five. Even if these were deposited into separate accounts, the repeating sequences of five $500 money orders could point to someone trying to stay below the $3,000 ID threshold if the relationship among the deposits is detected. In an embodiment, link analysis and sequence matching algorithms may be designed to find hidden relationships among events and entities. Link analysis may examine pairs of linked entities and organize this information into larger webs of interrelated entities. Sequence matching may be employed when the sequence of events (such as the time sequence) contains some important clue into hidden relationships. Many of the most insidious scenarios may only be solved with this type of complex analysis because the behavior may be spread over many events over multiple entities over a range of time.

The use of advanced behavior detection 512 is illustrated in FIG. 5 where a plurality of events and entities are monitored and where the relationships between those events and entities may be tabulated, analyzed and monitored using algorithms as described herein. Alerts may be generated based on the events and entities monitored, and the alert reporting may include references to these specific events and entities such that the details of those events and entities may be readily accessed.

Advanced behavior detection may be represented using an n-dimensional approach in which several types of events and entities are simultaneously considered across products and lines of business in order to identify the behavior of interest. The advanced behavior detection may be based not only on the events and entities that are known to be indicative of a behavior of interest, but also on the relationships, whether temporal or spatial (e.g. physical or electronic location) between those elements.

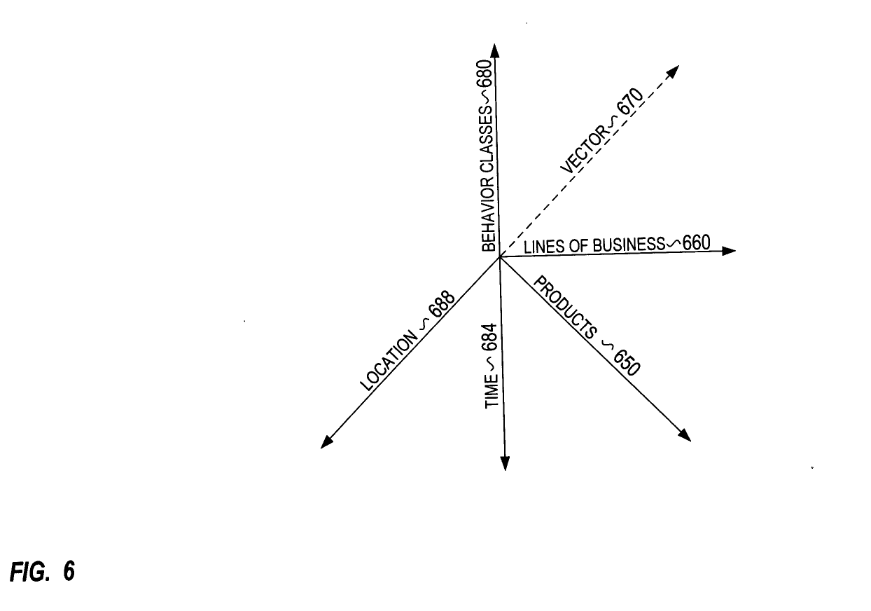

FIG. 6 illustrates an n-dimensional space describing the problem of behavior detection according to an embodiment. Time axis 684 may represent the time at which an event occurs. Location axis 688 may represent the virtual or physical location of an entity or an event. Products axis 650 may relate to a variety of goods or services with examples including, but not limited to, financial services, telecommunications, healthcare and consumer goods. As an illustration, products axis 650 for the financial services industry may include equity, bonds, commodities and/or options; for the telecommunications industry it may include data, wireless services, land-line and/or pager services; for the healthcare industry it may include MRI, X-ray, office visits and/or blood work; and for the consumer goods industry it may include food, cosmetics, over-the-counter medicines and/or jewelry. Lines of business axis 660 may be defined as the type of business involved. Examples include, but are not limited to, retail, wholesale, private and institutional types of business. Behavior classes axis 680 may represent a range of behaviors of interest. In the case of financial services these behaviors may include fraudulent behavior, money laundering or other licit or illicit activities. In the case of health care or insurance, the behaviors of interest may also include fraudulent activities. Although fraudulent behavior is frequently the behavior of interest, positive behaviors may also be specified. The vector 670 of FIG. 6 may represent one or more additional vector(s) that may provide additional dimensions for identifying targeted behaviors of interest. As an example, vector 670 may be the provider type in a health care embodiment, where the provider type includes doctor, medical device, pharmaceuticals and/or non-doctor service.

Referring to FIG. 6, events and entities lie somewhere within the n-dimensional space described by the basis vectors. A basic behavior may be a single point or clustered set of points in the n-dimensional space. Basic behavior detection may include locating the points of interest. Advanced behavior may be a complex set of points in the n-dimensional space, which are not necessarily in close proximity. Advanced behavior detection may include identifying those points by examining the relationships among those points and mapping those relationships to the advanced scenario.

FIG. 7A depicts an exemplary data transformation process according to an embodiment. System A 700, system B 704 and system C 708 represent external data sources or information systems containing raw or pre-transformed data. For illustration purposes, FIG. 7A represents these three systems, although the data transformation process may access data from any number of data sources or information systems. Transfer 736 may represent an exchange interface that transfers raw data 208 from the data source(s) or information systems to a consolidation/standardization process 712 where the data is converted to a consistent format. Transfer 716 may represent the transfer of the transformed data 212 to a data mart 720 where the transformed data 212 is stored. Data mart 720 may include a storage device and a database application in which the transformed data 212 is stored, retrieved and analyzed. Process 728 may represent manipulation of the transformed data 212. A flat file 724 may represent a pre-processed set of data that conforms to the data format required by the system and need not go through the transfer step 736. The flat file 724 may be stored in the data mart 720 through the interface 732. This description represents one possible embodiment of the invention for transferring raw data into a defined data model wherein transformed data 212 may be accessed.

FIG. 7B depicts representative tables involved in a data transformation process according to an embodiment. The table configuration and extracted data may vary depending upon the specific scenario or analysis being performed. FIG. 7B is representative of information that is extracted and transformed for a particular situation or purpose. Other types of tables, extracted data and associations may be used as part of the data transformation 300 process. In one embodiment, an account relationships table 750 may contain information such as account restrictions, relationships between accounts and/or servicing organization(s) for the account. An account balance and position table 752 may contain information such as current balance, current positions, group, investment objectives, option pairing and/or features. A managed accounts table 754 may contain information such as accounts managed by advisor, knowledge and/or approval. An investment accounts table 756 may contain information such as advisor, objectives, level of authority and/or accounts managed. A transactions table 758 may contain information such as open trade executions and/or electronic transfer of funds. Account data 760 may contain information such as the account holder's name, address, social security, phone number, email address and/or group. A customer to account relationship table 762 may contain information such as relationships between customers and accounts, roles that customers may assume and/or anticipated transaction profile. A customer relationship table 764 may contain information such as relationships between customers, trading restrictions, product knowledge and/or experience. A customer data table 766 may contain information such as customer name, gender, age, employer and/or income level. A reference data table 768 may contain information such as news, exchanges, indexes, code translator, history of changes, customers with controlling interest, lists of customers, security, users, logon, list and/or type. A trade and execution table 770 may contain information on completed transactions and/or electronic transfers. A solicitations table 772 may contain information on securities approved for solicitation and/or buy/sell orders for securities approved for solicitation. An employee and representative data table 774 may contain information on employee, representative and non-representative names, addresses, emails, groups, phone numbers, trading restrictions, organizations, relationships, locations and/or non-trade activities. A firm trade restrictions table 776 may contain information on employees with trading restrictions, securities watchlist and/or watchlist sources. A recommended securities table 778 may contain a list of securities that a firm is recommending, inventory lists, pending transactions in recommended securities, transaction histories of recommended securities and/or records of agents or brokers involved in the transaction of recommended securities. These tables or databases may be developed in a variety of computer-based languages or applications including, but not limited to, Java, C, C++, Access, dBase and products offered by Oracle and Sybase. Also, the field names may be customized to meet individual preferences, and the structure of the tables may be constructed to account for different possible implementations. The tables represented in FIG. 7B may be extracted from data contained in transformed data 212.

Link analysis may provide the ability to transform customer-to-customer business activities from a data representation, where they appear as individual activities between customers, to a third-party network representation, where they become group activities confined in each third-party network. One advantage of link analysis may be that group behaviors become more evident and are more effectively and efficiently analyzed in a third-party network representation since each group of customers connected through customer-to-customer activities becomes a single object in the network representation. The new network representation may form a third-party network platform.

FIG. 8 illustrates a representation of link analysis according to an embodiment. An item 872 may describe a variety of possible categories including, but not limited to, an account, entity, transaction or individual. A common link 876 may also describe a variety of possible categories including, but not limited to, account, entity, transaction or individual. An example 880 may provide a specific description of linkages based on the information provided in the diagram.

Item numbers #1 804, #2 808, #3 812, #4 816, #5 820 and #6 824 may represent similar categories for which behavior detection techniques and analysis are to be performed. Common link 876 categories A 860, B 864 and C 868 may represent similar categories for which behavior detection techniques and analysis are to be performed. Line 828 illustrates a link between #1 804 and A 860. Line 832 illustrates a link between #2 808 and A 860. Line 840 illustrates a link between #3 812 and B 864. Line 836 illustrates a link between #4 816 and A 860. Line 844 illustrates a link between #4 816 and B 864. Line 848 illustrates a link between #5 820 and B 864. Line 852 illustrates a link between B 864 and C 868. Line 856 illustrates a link between #6 824 and C 868. Descriptive field 884 describes the link between #1 804 and all other descriptive items 872 through the various common link 876 connections.

A network detection algorithm, such as link analysis, may be utilized to identify common elements between a plurality of events, entities and activities. As the associations extend beyond the original sources, the link analysis may identify common elements through direct or indirect association among the various events, entities and activities. Elements of interest may be retrieved, collected or processed from a general data source and may be stored in a separate database or dataset. As additional elements are evaluated, the matches and the link between matching elements may also be stored. This process may continue for the various elements and data sources.

Link analysis may be understood from the following example: if two accounts (A & B) were registered in different names but had a common address, the network detection algorithm would link the two accounts because of the matched address as a result of the direct connection. If another account were introduced (Z) which shared the same phone number as account A, then accounts A and Z would be linked through that direct association. In addition, accounts B and Z would be linked through their indirect association via account A. The network detection algorithm may be applied on a variety of elements, fields, datasets and databases in identifying directly or indirectly connected events, activities and entities. By creating and storing matches between elements, network detection algorithms may be able to extract data from a general data source in identifying events, entities and activities that have either direct or indirect associations.

A specific link analysis algorithm is presented in the co-pending, commonly-owned patent application entitled “Analysis of Third Party Networks,” filed on Jan. 13, 2003, having a Ser. No. 10/341,073, and incorporated herein by reference in its entirety. In addition, representative code corresponding to a link analysis method is provided below in the section entitled “Representative Code.”

FIG. 9 depicts a representation of sequence matching according to an embodiment. FIG. 9 provides three examples: example #1 900, example #2 904 and example #3 908. Example #1 900 includes a descriptive element 912 and a data sequence 916 with sequence matches 920, 924 and 928 that meet the test criteria established in descriptive element 912. Example #2 904 includes a descriptive element 932 and a data sequence 936 with sequence matches 940, 944 and 948 that meet the test criteria established in descriptive element 932. Example #3 908 includes a descriptive element 952 and a data sequence 956 with sequence matches 960, 964, 968, 972 and 976 that meet the test criteria established in descriptive element 952. This detection algorithm may be particularly useful when evaluating events, activities and/or behaviors in a certain sequence.

Sequence detection algorithms may analyze data for specific time-based patterns. As the data is analyzed, potentially significant and meaningful data may be temporarily stored in a separate database until further analysis of the remaining data stream(s) is completed. Since a sequence detection algorithm analyzes data for specific time or occurrence sequencing of events, activities and behaviors, the detection algorithm may analyze the entire dataset and save potential matches until its rule-based approach determines whether the temporarily stored data meets the sequence detection requirements. If a particular sequence of events, activities or other behaviors satisfies established constraints, a match may be confirmed, and the complete dataset capturing the events, behaviors and activities of interest may be saved. An alert may then be generated. If the analyzed data does not meet the established constraints, the temporarily stored data may be discarded, and no alert may be generated. In addition, sequence detection algorithms may be used not only to identify events, activities or behaviors that have occurred, but also to identify ones that have not occurred. Representative code corresponding to a sequence detection method is provided below in the section entitled “Representative Code.”

FIG. 10 illustrates a representation of outlier detection according to an embodiment. Example #1 1000 and example #2 1004 may define two particular examples of this algorithm. In example #1 1000, the Y-axis 1008 and the X-axis 1012 define the parameters for the data. Cluster 1016 may represent various data points based on the Y-axis 1008 and the X-axis 1012. Datapoints 1020 and 1024 may represent outliers that are significantly separated from the cluster 1016. In example #1 1000, an approach to detect outliers may use statistical analysis and regression modeling to identify points which are statistically significant (i.e., at least several standard deviations away from the mean). Example #2 1004 includes Y-axis 1028, X-axis 1032, clusters 1036, 1040 and 1044 and datapoints 1048 and 1052. In example #2 1004, traditional statistical analysis and regression analysis may not be effective. The clustering effect may create a higher standard deviation, as compared to Example #1 1000, and may make it more difficult to detect outliers. When multiple clusters are present, distances between data points within a cluster may first be compared. Then, that information may be compared with other points outside the clusters to determine whether or not such points are outliers. In example #2 1004, cluster 1044 is relatively close to datapoint 1048. As such, in example #2 1004, the only outlier identifiable may be datapoint 1052, which is significantly separated from each cluster. In either example, outliers may represent events, activities and/or behaviors that are atypical. Representative code corresponding to an outlier detection method is provided below in the section entitled “Representative Code.”

Algorithms for link analysis, sequence matching, outlier detection, rule pattern, text mining, decision tree and neural networks are commercially available including, but not limited to, SAS Institute's Enterprise Mining application, SPSS' Predictive Analytics™ application, International Business Machines' (IBM's) DB2 Intelligent Miner™ application, Visual Analytics' VisuaLinks™ application and NetMap Analytics' NetMap™ Link Analysis application.

As matches are identified through the detection algorithm analysis, the matches may be prioritized based on a rules-based methodology. Identified events, entities or transactions of interest may be evaluated based on user-defined logic to determine the relative prioritization of the match. The prioritization value may be saved with the match. In addition, the invention may group events, activities and transactions prior to transferring the alert into the routing and workflow process. The prioritization and grouping operations may be performed based on pre-defined criteria including parameters related to amounts, number of events, types of events, geographic locations of entities and events, parties involved in the events, product lines, lines of business and other parameters relevant to the type of behavior of interest. A user 128, an administrator 136, a domain expert 108 and/or a developer 104 may modify these parameters. During this step, summary information of the alert and associated dynamic link to the alert details may be saved along with prioritization and grouping information. The alert details may vary based on the event and entity of interest, but examples of such details include the account holder's name, address and phone number, the account balance, the amount of a transaction or series of transactions, and the recipient of a transfer or deposit. Representative code corresponding to prioritization and grouping methods are provided below in the section entitled “Representative Code.”

Once an alert has been prioritized and grouped, the alert may be routed and the workflow process may be managed for greater efficiency and effectiveness. Based on the prioritization and grouping of the alert, the alert may be routed using pre-determined instructions. Highlight information and dynamic links to detailed information may be provided to expedite and facilitate the review, investigation and processing of an alert. In addition, historical data and investigation data may be stored for later review and retrieval. The alert may be visually presented in a variety of formats, which may be selected by the user 128, the administrator 136, the domain expert 108 and/or the developer 104 and modified based on filtering elements.

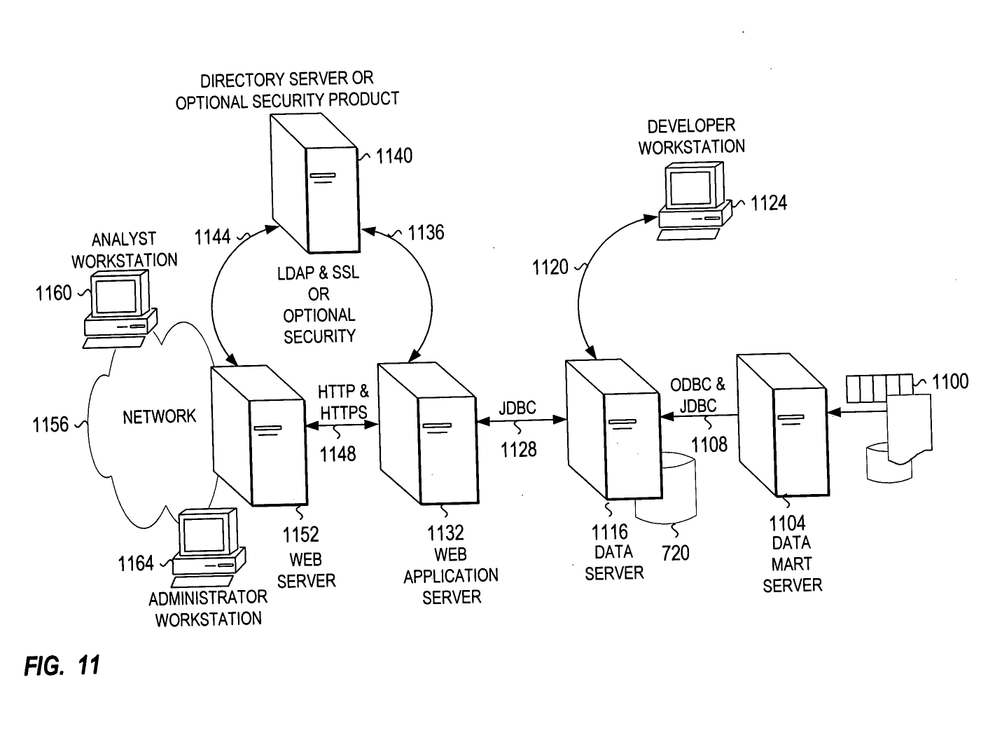

FIG. 11 depicts an exemplary networked infrastructure suitable for implementation of a system embodiment. Business data 1100 may be the equivalent of the raw data 208 (pre-transformed) and may come from a variety of data sources and information systems, including, but not limited to files, queues and databases that are contained on a data server 1104. The business data 1100 may be transferred 1108 to a data server 1116 and data mart 720. A developer interface 1120 may be provided to a developer workstation 1124 to enable interaction with the data mart server 1116. Information from the data mart server 1116 may be transferred 1128 to a web application server 1132, which may have an interface 1136 to a directory server/optional security product 1140. Data between the web application server 1132 and web server 1152 may be transferred through a link 1148. The web server 1152 may have an interface 1144 to the directory server/optional security product 1140 and may connect to a network 1156. Analyst workstation 1160 and/or administrator workstation 1164 may also be connected to the network 1156.

Workstations, network connections and databases for the implementation of the system are commercially available and methods for integrating these platforms are known to those skilled in the art. Exemplary servers may implement operating systems such as Solaris™, AIX™, Linux™, UNIX™, Windows NT™ or comparable platforms. Workstation and server equipment may be sourced from a variety of vendors, including, but not limited to Dell, Hewlett-Packard, IBM and Sun. The network 1156 may include an intranet, Internet, LAN, WAN or other infrastructure configurations that connect more than one workstation or server. The data mart 720 may represent a database structure including, but not limited to relational or hierarchal databases, which products are commercially available through vendors such as Oracle, IBM and Sybase, whose products sell under the trade names Oracle 8, DB2 and Adaptive Server, respectively. Protocols for transferring data, commands or alerts between the workstations, servers, data sources and network devices may be based on industry standards and may be written in a variety of programming languages. FIG. 11 represents one particular system configuration encompassing multiple servers. Different configurations are also possible in deploying the advanced scenario-based behavior detection system 200. For example, an embodiment consolidating two or more described functions into a single server or other network component may be implemented.

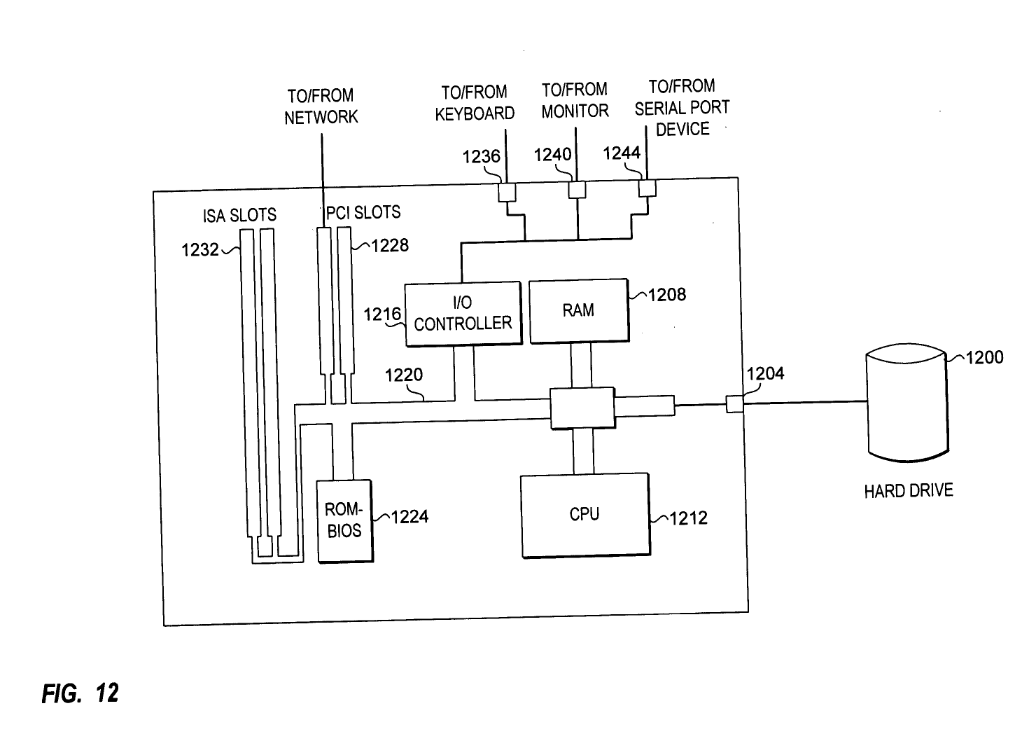

FIG. 12 depicts an exemplary block diagram for the realization of any of the workstations or server systems illustrated in FIG. 11. A system bus 1220 may transport data among the CPU 1212, the RAM 1208, Read Only Memory—Basic Input Output System (ROM-BIOS) 1224 and other components. The CPU 1212 may access a hard drive 1200 through a disk controller 1204. The standard input/output devices may be connected to the system bus 1220 through the I/O controller 1216. A keyboard may be attached to the I/O controller 1216 through a keyboard port 1236, and the monitor may be connected through a monitor port 1240. The serial port device may use a serial port 1244 to communicate with the I/O controller 1216. Industry Standard Architecture (ISA) expansion slots 1232 and/or Peripheral Component Interconnect (PCI) expansion slots 1228 may allow additional cards to be placed into the computer. In an embodiment, a network card may be inserted to permit connection to a local area, wide area or other network.

The present invention may be realized in a number of programming languages including C, C++, Perl, HTML, Pascal and Java®, although the scope of the invention is not limited by the choice of a particular programming language or tool. Object oriented languages have several advantages in terms of construction of the software used to realize the present invention, although the present invention may be realized in procedural or other types of programming languages known to those skilled in the art.

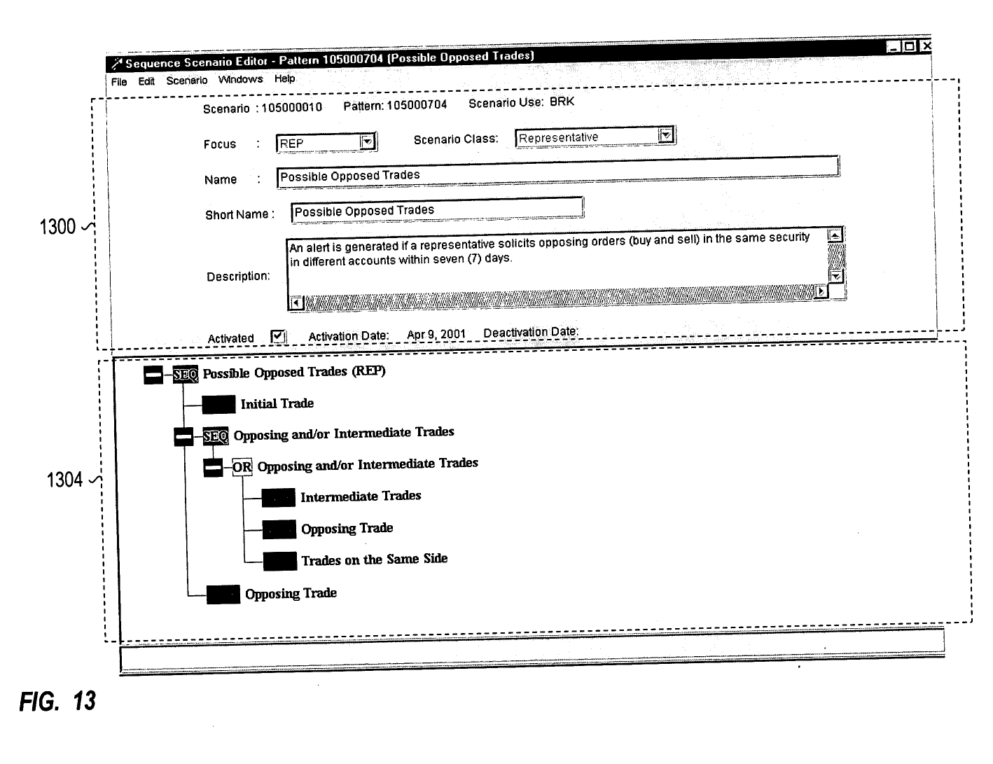

FIG. 13 illustrates an exemplary graphical user interface for a sequence scenario editor according to an embodiment. Scenario editor descriptive elements 1300 may contain information used to describe a particular scenario that is being considered. Certain sub-fields may be fixed and provided by the system, such as “Pattern” and “Scenario Use,” whereas the remaining fields may be modified to provide additional information on the particular scenario. Scenario representation 1304 may describe the associated scenario by providing information on the process, steps, loops and/or other elements involved in a particular application. In the example shown in FIG. 13, scenario representation 1304 may illustrate the advanced scenario of possible opposed trades in which a broker (the focus) may be soliciting both buy and sell orders on the same security, an unethical and therefore unacceptable (to the NASD) behavior. Scenario representation 1304 shows that an initial trade for a security is registered. Once that initial trade has been completed, opposing and/intermediate trades may be reviewed to identify if those trades were made for the same security.

Scenarios may use thresholds to specify detection parameters. In an embodiment, thresholds may apply to a pattern defined within a scenario, or may apply to a dataset related to a scenario (when a threshold applies to a dataset, the threshold may be used during the retrieval of the dataset). Once a scenario has been created, the user or operator may use a threshold manager to create, update, and delete thresholds; create and delete threshold sets; specify current values for thresholds; and/or remove thresholds from use. A threshold set may include a collection of thresholds that are associated with a specific scenario and form part of the scenario's detection logic for a specific application environment. As noted above, an application environment may be a particular business or institution, geographic area, jurisdiction, etc. Multiple threshold sets may be created for each scenario, each threshold set having values appropriate to a given application environment. When a threshold is added to a scenario, it may be added to that scenario's base threshold set. The base threshold set may include the default threshold set for a scenario, which may be used if no other threshold set is specified. The user may create new (derived) threshold sets, which include the base threshold set. Derived threshold sets may contain copies of all the thresholds contained in the base threshold set. The individual thresholds within a derived threshold set may inherit the values of the thresholds in the base threshold set or may define new values.

FIG. 14A illustrates an exemplary graphical user interface for a threshold definer according to an embodiment. The threshold definer may allow the user to add, modify, and delete thresholds for a base threshold set. Threshold list 1400 may provide a list of thresholds within the base threshold set of the scenario. Furthermore, threshold list 1400 may provide additional information, including, but not limited to “Name,” “Display Name,” “Description,” “Units” and “Data Type” to more fully describe the thresholds, their attributes and/or their use. Definer area 1404 may provide a user 128, a developer 104, a domain expert 108 and/or an administrator 136 with the ability to add, modify and/or change attributes and/or values associated with each of the thresholds in threshold list 1400. For example, the modifiable thresholds and attributes may include name, display name, default value, current value, max value, min value, data type and/or units. Sub-field elements may also contain drop down menus to simplify use. By highlighting a row within threshold list 1400, the associated information may be retrieved and displayed in the definer area 1404 section.

FIG. 14B illustrates an exemplary graphical user interface for a threshold uses feature according to an embodiment. The threshold uses feature may define how each threshold associated with a scenario is used by the patterns and/or datasets associated with the scenario. For example, it may permit the user to remove a threshold from an individual pattern or dataset without affecting the use of the threshold in other patterns or datasets. Referring to FIG. 14B, threshold list 1410 may provide a list of thresholds within the base threshold set of the scenario. Pattern list 1412 may show each pattern within the scenario that is associated with the threshold selected in threshold list 1410. Each row of pattern list 1412 may display, for example, a Pattern ID, a Pattern Name, and a Pattern Owner. A Remove from Pattern button 1413 may be used to remove the selected threshold from the selected pattern and replace it with the current value of the base threshold. Datasets list 1414 may show each dataset that is associated with the threshold selected in threshold list 1410. Each row may display the DataSet ID, DataSet Name, and DataSet Owner. Remove from Dataset button 1415 may be used to remove the selected threshold from the selected dataset and replace it with the current value of the base threshold.

FIG. 14C illustrates an exemplary graphical user interface for a threshold set feature according to an embodiment. The threshold sets feature may allow a user and/or an administrator to add, modify and/or delete threshold sets within a scenario. In an embodiment, each threshold in a threshold set may either inherit its current value and default value from the base threshold set or receive a different current value and default value based on user input. Referring to FIG. 14C, a derived threshold set (a threshold set derived from the base threshold set for the scenario) may be chosen by the threshold set menu 1420. Threshold matrix 1422 may depict all of the thresholds in the selected threshold set. Threshold matrix 1422 may allow a user to view and/or set a variety of details and values for each of the thresholds. Threshold matrix 1422 may contain, for example, the following columns: the display name of the threshold, an indication of whether the threshold inherits its current value and default value from the base threshold set, the current value of the displayed threshold, and the default value of the displayed threshold. A Display Threshold History button 1424 may be provided to allow a user or administrator to view a history for a selected threshold.

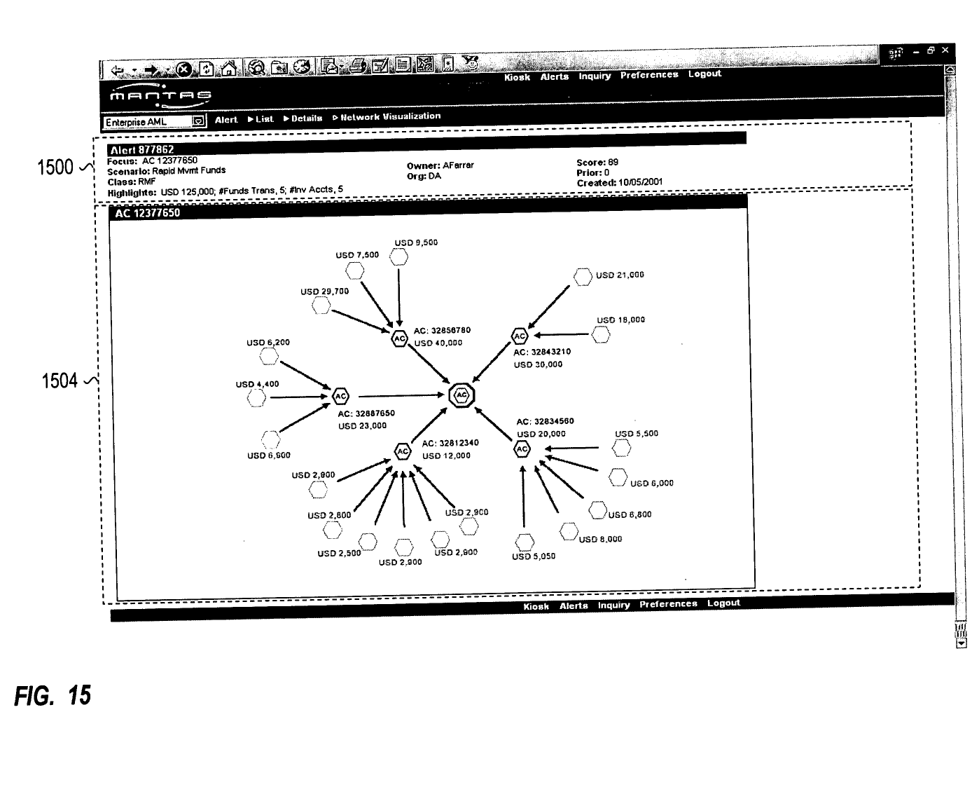

FIG. 15 illustrates an exemplary graphical user interface and display for network visualization of alerts according to an embodiment. Alert summary information 1500 may provide summary information related to the alert including focus, scenario, class, highlights, owner, organization, prioritization and the date the alert was created. The alert visualization 1504 section may be a graphically generated representation of the behavior, activity or event of interest. In FIG. 15, an example of networks of related accounts is provided. In the alert summary information 1500 section, a unique alert ID may be generated in order to track this event. Additional information may also be provided identifying the amount of money in question, along with the number of accounts and activities involved. As part of the case management process 316, an owner and organization may be assigned to this alert. The alert visualization 1504 section may depict a representation of the transfers and amounts in question.

FIG. 16 illustrates an exemplary graphical user interface for alert display, alert filtering and alert viewing according to an embodiment. The filtering elements 1600 may contain a plurality of sub-fields used to modify the presentation of alerts. For example, the sub-fields may include organization or owner, scenario class or scenario, prioritization, focus, age and/or status. Organization may refer to a list of internally defined groups involved in the detection process. Owner may refer to individuals or groups that have been assigned various alerts. A user 128, an administrator 136, a domain expert 108 and/or a developer 104 may select the filtering elements 1600 sub-fields in affecting what information is displayed and in what order.

Referring to the user interface shown in FIG. 16, multiple alerts are shown in an alert list 1604. The alert list 1604 may contain a prioritization column 1640, where the prioritization SC represents a numeric value derived from the application of the scenarios and the parameterized values within the scenarios. A user 128, a domain expert 108, a developer 104 or an administrator 136 may modify the visual presentation of alerts based on the alert prioritization. A focus column 1641 may indicate the centralized event or entity of interest. A class column 1642 labeled CL may indicate the general class of behavior (e.g. money laundering). A scenario column 1644 may list the scenario name. A highlights column 1646 may provide the summary information of the individual events and entities. A prior column 1648 may indicate the history of alerts on that focus (e.g. the number of prior alerts). An owner column 1650 may indicate the user 128 who has been assigned the alert. An organization column 1652 may indicate the organization in which the user 128 resides. An age column 1652 may indicate an age such as the number of days since the alert was created. A status column 1656 may indicate the status of the alert, examples of which may be open, closed, pending and transferred. A details column 1658 may provide links, preferably in the form of hyperlinks to alert details, such as those illustrated in FIG. 17.

In the user input section 1600, the user 128, administrator 136, domain expert 108 and/or developer 104 may select how the data is to be presented by sorting the output based on, for example, the prioritization, focus, class, scenario, prior alerts (prior), owner, organization (org), age or status followed by the number of views retrieved at one time (e.g., 10, 20, 50 or 200 alerts). In one embodiment, these selections may be made through the use of pull down entry fields and/or numerical entry fields. Within the filtering elements section 1620, the user 128, administrator 136, domain expert 108 and/or developer 104 may filter based on organization, owner, scenario class, scenario, prioritization, focus, age and/or status. Within the sort-by section 1624, the user 128, administrator 136, domain expert 108 and/or developer 104 may have the information displayed by ranking or grouping based on prioritization, focus, class, scenario, prior alerts (prior), owner, organization, age and/or status.

FIGS. 17 and 18 are representative of a graphical user interface for displaying information related to case management 316. FIG. 17 illustrates an exemplary graphical user interface for viewing alert details according to an embodiment. The alert status 1700 section may contain summary and status information relevant to the alert in question including, without limitation, focus, scenario, class, highlights, owner, organization, prioritization, priority and/or date the alert was created. The focus may include an event or entity of interest. The scenario may include a specific type of detected behavior or activity of interest. The class may include a general description of the type of scenario. Highlights may provide summary information on the alert. The owner may include an individual or group assigned to investigate the alert. The organization may include a department overseeing this activity. The prioritization may include a numeric value associated with the alert derived from the advanced behavior detection and alert generation system. The priority may include a value associated with the importance and urgency of the alert, which may be based on several factors. The created field may include the date the alert was generated. The alert details 1704 section may provide specific detailed behavior, event and activity-based information on the alert in question. Information on the customer bank, name, type, business unit, watchlist and location may be provided automatically by the system. Additional information may be included depending upon the type of alert generated. The visual presentation of the detailed information may expedite the users' ability to quickly and accurately identify behaviors, activities or events of interest that require further review or investigation or that enable the user to determine that the behaviors, events or activities in question are legitimate.

FIG. 18 illustrates an exemplary graphical user interface for viewing alert detail according to an embodiment. The alert transaction 1800 section may provide information on current alerts. The alert history 1804 may provide history information on related elements of the alert transaction 1800. The history information may be linked through a plurality of fields or sub-fields. The previous alert transactions 1808 section may provide information on past transactions that were completed based on earlier events. Accordingly, the alert history screen capture may allow current alert information to be reviewed in context with past alert history and transactions. While an investigation or review of a single event may not provide any meaningful insights or understandings, having historical and transactional data may be extremely valuable in creating a contextual overview of behavior, events or actions.

FIGS. 19 and 20 are exemplary graphical user interfaces displaying information related to reporting 320 according to an embodiment. The interfaces may be coded in a variety of computer languages including, but not limited to, Java®, C and C++.

FIG. 19 illustrates an exemplary graphical user interface for workload management according to an embodiment. The workload management filters 1900 section may contain a plurality of fields or sub-fields wherein information or values may be altered to affect the filtering of associated data. Such sub-fields may include organization, owner, scenario class, scenario and/or age. The workload management report 1904 section may provide information related to report generation. Information included in this section may include report generation date and time along with a segmentation of selected alerts based on age of the alert. The workload management detail 1908 section may provide specific alert information based on filtering elements provided in the workload management filters 1900 section. In this section, information may be presented based on the filtering elements contained in the workload management filters 1900 section. The presented information may be grouped by organization and by owner. New alerts, open alerts and reopened alerts columns may provide numeric values both for the number of alerts affected and the age of the alerts. The workload management detail 1908 section may also provide information on the average alert age by organization and the total of each column, which may facilitate more efficient and effective workload process management.

FIG. 20 illustrates an exemplary graphical user interface for alert disposition according to an embodiment. The alert disposition filter 2000 section may contain a plurality of fields or sub-fields wherein information or values may be altered in affecting the filtering of associated data. Fields may include, without limitation, organization, owner, alerts created during a specific period, scenario class, scenario and/or prioritization. The alert disposition report 2004 section may provide information related to the alert disposition report. Filtering information provided in the alert disposition filter 2000 may be confirmed in the alert disposition report 2004 section along with summary information of the number of relevant alerts broken down into further classifications. The generated field may provide a numeric value of the total number of alerts based on the filters. The Below Thresholds field may be a numeric value for alerts that do not meet certain threshold limits. A user 128 may modify the threshold if the Below Thresholds value is too large. The System Autoclosed field may represent a numeric value of alerts that the system automatically evaluated and closed without requiring further review or investigation based on applying intelligence and system rules. The Pending System Autoclose field may represent the number of alerts that are in the process of being closed through user review and investigation. The alert disposition detail 2008 section may provide specific alert information grouped based on filtering elements provided in the alert disposition filter 2000 section. The alert information may be grouped based on organization. Owners within the organization may be further segmented with information provided based on their workload results. An additional category in the alert disposition detail 2008 section may provide closing details. This category may contain a plurality of columns in which alerts have been assigned. The numeric values in these columns and rows may be related to the numeric values associated with individual owners. AWH may refer to the number of actions withheld. IAE may refer to the number of invalid alerts or system errors. CO may refer to the number of cases opened. DUP may refer to the number of duplicate alerts. CTR may refer to the number of CTRs filed. TTC may refer to the number of transfers. CS3 may refer to the number of alerts closed and suppressed for 3 months. CS6 may refer to the number of alerts closed and suppressed for 6 months. CSY may refer to the number of alerts closed and suppressed for one year. SAR may refer to the number of suspicious activity reports filed. The alert disposition definitions section 2012 may contain definitions related to the alert disposition detail section 2008.

The many features and advantages of the invention are apparent from the detailed specification. Since numerous modifications and variations will readily occur to those skilled in the art, it is not desired to limit the invention to the exact construction and operation illustrated and described. Accordingly, all appropriate modifications and equivalents may be included within the scope of the invention.

Representative Code

The following text includes representative pseudocode for an embodiment of various functions and features described above. The description set forth below is only exemplary and the invention is not limited to the specific description set forth as representative code.

Link Analysis/Network Detection

Read input parameters: One or more datasets, list of internal node characteristics, description of external node characteristics, logic constraints.

For each dataset:
Read a row consisting of a From node, a To node and a Link Type
If one of the existing networks contains either the From node or To node, then add this row to that network.
If one existing network contains the From node and a different existing network contains the To node, then merge those two networks and add this row to the merged network.
If no existing networks contain either the From node or To node, then create a new network consisting solely of this row.
Return to “Read a row” step until all rows are read from all datasets.
Examine each network that has been constructed; if it does not meet the minimum size parameter; delete it.
For each remaining node, if the node is of a prunable type and is only linked to one other node, discard it and all links associated with it.
Examine each remaining network; if it does not meet the minimum size parameter, delete it and all links and nodes that are members.
For each network: Capture Internal Characteristics (e.g., Number of nodes in the network, ID of the Primary Node in the network, Number of nodes to which the Primary Node is linked, Primary Node total measure (sum of the weight of the links associated with the Primary Node, both incoming and outgoing links), Primary Node incoming measure (sum of the weight of links with directionality into the Primary Node), Primary Node outgoing measure (sum of the weight of links with directionality away from the Primary Node), Number of links in the network, Average weight of the links in the network, Maximum weight of a link in the network, Earliest timestamp of a link in the network, Latest timestamp of a link in the network, Number of links with directionality into the Primary Node, Number of links with directionality away from the Primary Node, Number of links associated with the Primary Node with no directionality, Business ID of the Primary Node).
For each network: Capture External Characteristics. These are characteristics of the network that can only be measured by accessing external data sources in conjunction with the network nodes.
Compare each network against Logic Constraints.
Create a match for each network that matches the Logic Constraints.
Output all Matches.
   Sequence Detection

Read input parameters: One or more Datasets, Sequence pattern. Sequence pattern consists of:
A Top Level Sequence Node. The Top Level Sequence Node contains a “Longest/Shortest” flag that tells whether the longest or shortest match found should be saved. The Top Level Sequence Node may contain a “Distance Range” that specifies the time range within which the matched rows must fall.
Sequence Nodes have one or more child nodes. The node types of these children may be: another Sequence Node, an Or Node or a Row Node.
Sequence Nodes may contain a “Looping Range” that specifies how many times the Sequence may match.
Or Nodes may have one or more child nodes. The node types of these children may be: a Sequence Node, another Or Node or a Row Node.
Row nodes contain the following parameters:
   A dataset to be matched (“Dataset”)
   A “Looping Range”
   A Boolean logic constraint (“Logic Constraint”)
   A set of variable to bind (“Variables”) and expressions for calculating the Variable's value (“Expressions”)
   A Record/No-record Flag
Initialize datasets
   Read each Dataset. Each Dataset has a list of fields that should be used to sort the dataset.
   Sort each dataset individually.
Find matches:
   Select the next row to be matched. If there are multiple datasets, this is done by examining the next row in each individual dataset and picking the one with the lowest value of shared ordering attributes.
   Create a Partial Match State positioned at the Top Level Sequence Node.
For each Partial Match State:
If it is positioned at a Sequence Node, create a new Partial Match State positioned at the first child node. The new Partial Match State is added to the list of States yet to be evaluated.
If it is positioned at an Or Node, create a new Partial Match State for each child node. Position each at the corresponding child node. The new Partial Match States are added to the list of States yet to be evaluated.
If it is positioned at a Row Node, do the following:
   Check if the dataset row comes from the same dataset as the Dataset specified in this Row Node.
   If so, proceed to next step. Otherwise, continue with the next Partial Match State.
   Compare the Logic Constraint to the Dataset rows contents.
   If Logic Constraint evaluates to true, proceed to next step. Otherwise, continue with the next Partial Match State.
   Bind all Variables to value resulting from evaluating corresponding Expression.
   If Record/No-record flag is set to Record, store matched row to be output with alert.
   Create new Partial Match States that point to nodes following this Row Node. If this Row Node is a child of a Sequence Node, then a new state is added positioned at the next child. If this Row Node has a Looping Range that has not reached its maximum value, then also create a new state positioned at this Row Node. If this Row Node is a child of an Or Node or the last child of a Sequence Node then also create a new state positioned after the parent node. If this Row Node the last child of a Sequence Node that has a Looping Range that has not reached its maximum value, then also create a new state positioned at the parent Sequence Node. These new Partial Match States are saved until the next dataset row is read.
If it is positioned after the last child of the Top Level Sequence Node, then create a Match consisting of matched rows and bound Variables if the time between the first matched event and the last matched event within the Top Level Sequence Node's Distance Range. If a previous Match exists that started with the same dataset row, then:
   If the Top Level Sequence Node Longest/Shortest flag is set to Longest, throw out previous match and keep this match.
   If the Top Level Sequence Node Longest/Shortest flag is set to Shortest, throw out this match and keep previous match.
Return to initial step, “Select the next row to be matched” unless there are no more rows to examine in any datasets.
Output all matches.
   Outlier Detection

Read input parameters: Dataset and Outlier Detection Pattern. Outlier Detection Pattern consists of:
Multiple sets of one or more Dimensions (“Dimension Set”). Each Dimension is mapped to a field in the dataset.
A Target Point. This is a value for each Dimension in each Dimension Set.
A Neighborhood Size.
A Minimum Dimension Set Count.

Find matches:
For each Dimension Set:
   For each row in the dataset, calculate the distance between that row and the target point (both as projected onto the Dimension Set).
   Find the K rows closest to the target point where K=Neighborhood Size. These K rows compose this Dimension Set's Neighbors.
For each row in the dataset, count the number of Dimension Sets that include that row as a Neighbor.
If that count is >=the Minimum Dimension Set Count, create a match for that row consisting of the row.
Output all matches.
   Rules-Based Detection

Read input parameters: Primary Dataset, zero or more Secondary Datasets, Rule pattern. Rule pattern consists of (for each dataset):
Set of Boolean logic constraints (“Logic Constraints”)
A number range constraining the number of rows matched (“Rows Matched Range”)
A set of variable to bind (“Variables”) and expressions for calculating the Variable's value (“Expressions”)
A Record/No-record Flag
A field in dataset that maps to Scenario Focus (“Focus Field”)

Find matches:
Read row from Primary Dataset.
Compare Primary Dataset's Logic Constraints to row contents.
If Primary Dataset's Logic Constraints evaluate to true, then proceed to next step. Otherwise go back to “Read row from Primary Dataset” step.
Bind all Variables to value resulting from evaluating corresponding Expression.
If Record/No-record flag is set to Record, store matched row to be output with alert.
Bind Focus to value in Focus Field
For each Secondary Dataset:
   Read rows from Secondary Dataset with Focus Field value matching Focus.
   For each row, compare Secondary Dataset's Logic Constraint to row contents.
   Count number of rows that match Logic Constraint.
   If count is within Rows Matched Range, then proceed to next step. Otherwise, go back to “Read row from Primary Dataset” step.
   Bind all Variables to value resulting from evaluating corresponding Expression.
   If Record/No-record flag is set to Record, store matched rows to be output with alert.
Create alert. If constraint is met for Primary Dataset and Rows Matched Range is satisfied for all Secondary Datasets, then create alert consisting of Focus, recorded rows and variables.
Return to “Read row from Primary Dataset” step.
Output all alerts.

What is claimed is:

1. A computer based method for detecting a behavior, the method comprising:
receiving data from at least one source;
determining an application environment corresponding to the data;
retrieving a scenario, wherein the scenario comprises one or more parameterized patterns indicative of one or more behaviors;
retrieving one or more parameter sets applicable to the one or more parameterized patterns, wherein each parameter set comprises one or more parameters;
selecting one of the one or more parameter sets based on the application environment;
forming a dataset, wherein the dataset includes a portion of the received data, one or more events and one or more entities; and
detecting one or more matches between the dataset and the one or more parameterized patterns with the selected parameter set.

2. The method of claim 1 wherein detecting one or more matches comprises:
performing sequence matching to identify sequences in the one or more events; and
relating those sequences to the one or more entities in the dataset.

3. The method of claim 1 wherein detecting one or more matches comprises one or more of the following:
performing link analysis to establish connections between a plurality of entities and events in the dataset;
performing rule-based analysis to identify one or more entities and one or more events in the dataset based on rules specifying parameters and thresholds; and
performing outlier detection analysis to identify at least one event and at least one entity outside of a defined range.

4. The method of claim 1, further comprising:
generating one or more alerts based on the existence of one or more matches.

5. The method of claim 1, further comprising:
generating one or more reports based on the existence of one or more matches.

6. A computer readable medium embodying program instructions for detecting a behavior, the computer readable medium comprising instructions for:
receiving data from at least one source;
determining an application environment corresponding to the data;
retrieving a scenario, wherein the scenario comprises one or more parameterized patterns indicative of one or more behaviors;
retrieving one or more parameter sets applicable to the one or more parameterized patterns, wherein each parameter set comprises one or more parameters;
selecting one of the one or more parameter sets based on the application environment;
forming a dataset, wherein the dataset includes a portion of the received data, one or more events and one or more entities; and
detecting one or more matches between the dataset and the one or more parameterized patterns with the selected parameter set.

7. The computer readable medium of claim 6 wherein the detecting one or more matches comprises instructions for one or more of the following:
performing sequence matching to identify sequences in the one or more events in the dataset and relating those sequences to the one or more entities in the dataset;
performing link analysis to establish connections between a plurality of entities and events in the dataset;
performing rule-based analysis to identify one or more entities and one or more events in the dataset based on rules specifying parameters and thresholds; and
performing outlier detection analysis to identify at least one event and at least one entity outside of a defined range.

8. The computer readable medium of claim 6, further comprising instructions for:
generating one or more alerts based on the existence of one or more matches.

9. The computer readable medium of claim 6, further comprising instructions for:
generating one or more reports based on the existence of one or more matches.

10. The computer readable medium of claim 6 wherein the medium comprises one or more of magnetic data storage disks, magnetic tape, alterable electronic read-only memory, non-alterable electronic read-only memory, electronic random-access memory, flash memory, optical storage devices, wired communication links, wired transmission media, wired propagated signal media, wireless communication links, wireless transmission media, and wireless propagated signal media.

11. A system for detecting a behavior, the system comprising:
a processor having circuitry to execute instructions;
a communications interface, in communication with the processor, for receiving data from at least one source;
a memory, in communication with the processor, for storing instructions for:
determining an application environment corresponding to the data;
retrieving a scenario, wherein the scenario comprises one or more parameterized patterns indicative of one or more behaviors;
retrieving one or more parameter sets applicable to the one or more parameterized patterns, wherein each parameter set comprises one or more parameters;
selecting one of the one or more parameter sets based on the application environment;
forming a dataset, wherein the dataset includes a portion of the received data, one or more events and one or more entities; and
detecting one or more matches between the dataset and the one or more parameterized patterns with the selected parameter set.

12. A method for configuring parameter sets for detection scenarios, the method comprising:
retrieving a base parameter set comprising one or more parameters for use in a detection scenario and a default value for each parameter;
generating one or more derived parameter sets, wherein each derived parameter set includes at least one parameter from the base parameter set;
setting at least one parameter in each derived parameter set to a value different than the default value for the corresponding parameter in the base parameter set; and
specifying, for each derived parameter set, an application environment to which the derived parameter set applies.

13. The method of claim 12 wherein at least one parameter applies to a pattern defined in the detection scenario.

14. The method of claim 12 wherein at least one parameter applies to a dataset defined in the detection scenario.
